(19) United States
(12) Patent Application Publication
(10) Pub. No.: US 2021/0114901 A1
(43) Pub. Date: Apr. 22, 2021

(54) METHOD FOR TREATING WASTEWATER VIA A FLOCCULATING MINERAL COMPOSITION

(71) Applicants: William J Cox, Indialantic, FL (US); Billy Ray White, Orlando, FL (US)

(72) Inventors: William J Cox, Indialantic, FL (US); Billy Ray White, Orlando, FL (US)

(21) Appl. No.: 17/251,746

(22) PCT Filed: Jan. 28, 2019
(86) PCT No.: PCT/US19/15436

§ 371 Date: Dec. 11, 2020

Related U.S. Application Data
(60) Provisional application No. 62/683,066, filed on Jun. 11, 2018.

(51) Int. Cl. C02F 1/52; C02F 7/00; C02F 3/12; C02F 1/32; C02F 1/76; C02F 1/78

(52) U.S. Cl. CPC C02F 1/5263; C02F 1/5227; C02F 7/00; C02F 3/1215; C02F 3/1257; C02F 2101/105; C02F 1/76; C02F 1/78; C02F 2303/04; C02F 2303/24; C02F 1/32

(57) ABSTRACT

A method for treating wastewater is provided. The method uses a cationic mineral composition, which is a cationic clay composition, to assist with flocculating out biomass suspended within the wastewater. The cationic clay composition may be mixed with the wastewater undergoing a wastewater treatment process at numerous injection sites. Mixing the cationic clay composition with wastewater at these injection sites may provide different benefits, wherein these benefits are dependent on the point at which the wastewater is along the wastewater treatment process. The cationic clay composition may be added at one injection site or multiple injection sites, depending on a determination made by the operator.

### CROSS REFERENCES

This application claims the benefit of U.S. Provisional Application No. 62/683,066, filed on Jun. 11, 2018, which application is incorporated herein by reference.

### FIELD OF THE DISCLOSURE

The subject matter of the present disclosure refers generally to a process for treating wastewater.

### BACKGROUND

Current wastewater treatment plants use large amounts of harsh chemicals to both flocculate dissolved, suspended, and colloidal biosolids and disinfect the wastewater before it is released into a receiving stream. These chemicals enter the environment and build up over time, damaging the ecosystem into which the wastewater is released. For instance, chlorine used as a disinfectant in wastewater treatment plants can adversely affect wildlife if it reaches the receiving stream. Chlorine gas can also have an adverse effect on the atmosphere. In particular, chlorine gas can adversely affect the ozone layer as chlorine free radicals react readily with ozone in the atmosphere to create halogen oxides. Additionally, chemicals currently heavily used in wastewater treatment can be expensive as well as pose health risks to the workers who operate the wastewater treatment plants. For instance, the coagulating polymers often used during wastewater treatment may cause skin, eye, respiratory, and gastrointestinal irritation to any worker who may come in contact with the coagulating polymer.

Further, current methods of wastewater treatment that use these harsh chemicals often require additional work to prevent damage to the various systems of the wastewater treatment plant or to create quality biosolids that may be reused to provide food for microorganisms of the system. For instance, the coagulating polymers used to create sludge from the dissolved, suspended, and colloidal solids can form large masses that may place strains on the various systems of the wastewater treatment plant if not monitored. Coagulating polymers also are not used to remove sulfur-containing compounds early in the treatment process that may otherwise form hydrogen sulfide and sulfuric acid as microorganisms break these sulfur containing compounds down during treatment. Utilization of Aluminum Sulfate, used for both settability and screening, also adds sulfur-forming compounds during wastewater treatment, which further exacerbates hydrogen sulfide and sulfuric acid issues. Sulfuric acid can be particularly devastating to a wastewater treatment facility as it can readily corrode the concrete and steel pipes frequently used during plant operations. Additionally, sludge produced by systems using the coagulating polymers must often undergo centrifugation in order to create quality biosolids that may be reused by the wastewater treatment plant, which further increases the operating cost. Activated sludge returned to the wastewater treatment process, now containing these harmful chemicals, will eventually kill off the microbes (necessary for sludge decomposition) during secondary treatment, causing inadequate nitrification/denitrification that ultimately causes a decrease in the effectiveness of the wastewater treatment process at the plant.

Accordingly, there is a need in the art for an improved process to treat wastewater that may reduce or eliminate chemicals typically used in wastewater treatment plants today.

### SUMMARY

In one aspect, a process for treating wastewater is provided. The process reduces or eliminates the need to utilize aluminum sulfate, coagulating polymers, chlorine, and other chemicals currently used to treat wastewater that degrade effluent quality and pollute receiving waters. Generally, the process of the present disclosure is designed to treat wastewater using a cationic mineral composition, which is a cationic clay composition, in a way such that it causes biomass to floc out of wastewater. In some embodiments, the precipitate created by the various methods herein may be recycled. The systems in which the various methods herein are carried out may comprise a wastewater collection apparatus, preliminary treatment apparatus, secondary treatment apparatus, digestor apparatus, and disinfection apparatus. The wastewater treatment systems described herein generally refer to activated sludge processes, but one with skill in the art will recognize that the methods employed herein may be used for other wastewater treatment systems. Wastewater is collected by the systems and a cationic clay composition is added to the wastewater at numerous injection sites, which causes biomass within the wastewater to flocculate out. Some systems may further comprise a sedimentation apparatus that clarifies wastewater and sludge water of the system. Other systems may further comprise a flow equalization apparatus that regulates flow throughout the systems. The various systems may also comprise a denitrification apparatus that removes nitrogen from the wastewater. A coagulating polymer may be added to the wastewater to assist the cationic clay composition in flocculating out the biomass.

Wastewater may be defined as water containing suspended organic solids. If wastewater is not treated before being transported to receiving waters, the organic solids may deplete oxygen supplies in the receiving stream, which could cause fish kills and become a source of unpleasant odors, whereas wastewater containing heavy metals would cause serious lasting damage to environments were the heavy metals not removed prior to being released to the receiving waters. Wastewater can be treated by adding a flocculating compound that causes dissolved, suspended, and colloidal biomass of wastewater to flocculate out to create sludge containing large numbers of microorganisms that may consume biomass. A cationic clay composition is used as the flocculating compound in the methods herein. A coagulating polymer may also be used to floc out dissolved, suspended, and colloidal biomass. In one optional embodiment, the coagulating polymer is mixed with the cationic clay composition prior to being mixed with wastewater. The cationic clay composition may be mixed with a volume of water to create a slurry before addition to the wastewater. In some instances, addition as a slurry increases the effectiveness of the cationic clay composition and decreases turbidity of the resulting sludge water.

Wastewater is collected by the wastewater collection apparatus of the system. The wastewater collection apparatus may comprise lateral lines, main lines, manholes, gravity sewer lines, lift stations, and force mains. All of these systems work together to provide wastewater treatment plants for treating the wastewater produced by residential, commercial, and industrial areas within the plant's jurisdiction. Once the wastewater has been collected, the preliminary treatment apparatus is designed to screen out large, entrained, suspended, and floating solid pollution. These solids may include wood, cloth, paper, plastics, garbage, and fecal matter, or similar solid materials, or any combination thereof. Solids may be screened out of the wastewater by passing the wastewater through coarse screens and fine screens. In some embodiments, comminutors and grinders may be used to grind and shred solids into a smaller size. The preliminary treatment apparatus may also be designed to screen out heavy inorganic matter called grit. Inorganic material that may be categorized as grit includes, but is not limited to, sand, gravel, metal, and glass, or any combination thereof.

After the byproducts have been removed, the secondary treatment apparatus is designed to mix the wastewater and cationic clay composition in a way such that these floc out of suspension as well as increase oxygen levels for the microorganisms within the sludge water that are breaking down the biomass. Secondary treatment of the wastewater with the cationic clay composition may take place in at least one of an: oxidation ditch reactor, sequence batch reactor, extended aeration reactor, contact stabilization reactor, fixed film reactor, and plug flow reactor, or any combination thereof. However, other types of secondary treatment apparatuses may be used. Secondary treatment removes soluble organic matter and any remaining suspended and/or colloidal biomass that may have escaped preliminary treatment. Removal of soluble organic matter and suspended and/or colloidal biomass during secondary treatment may be accomplished via microbial processes that consume the organic waste and convert it into carbon dioxide, water, and energy.

An oxidation ditch system may be defined as a modified activated sludge wastewater treatment process comprising an oxidation ditch reactor that enables the system to use long solids retention times (SRTs) to remove biomass and increase its ability to remove both nitrogen and phosphorous. Oxidation ditch reactors typically comprise a basin having a ring, oval or horseshoe shape. This basin may have a single or multichannel configuration. Mounted aerators (mechanical aeration) circulate the wastewater within the basin as well as facilitate oxygen transfer and aeration. A sequence batch system may be defined as a modified activated sludge wastewater treatment process comprising at least one aeration tank that bubbles oxygen through wastewater and activated sludge in batches to reduce dissolved and suspended and/or colloidal biomass. Equalization, aeration, and clarification can all be achieved using a single batch reactor. However, two or more batch reactors may be used in sequence to optimize results. An extended aeration system may be defined as a modified activated sludge wastewater treatment process comprising at least one compartmentalized tank (extended aeration reactor) designed to reduce dissolved, suspended, and colloidal biomass under aerobic conditions. Oxygen required to sustain the aerobic biological processes may be supplied by mechanical means or diffusion means.

A contact stabilization system may be defined as a modified activated sludge wastewater treatment process comprising a contact reactor and a stabilization reactor separated by a sedimentation tank. The contact reactor receives the wastewater and the biomass in a starved condition so that soluble material is readily adsorbed by the starved biomass. The mixed liquor leaving the contact reactor is settled and the biomass is concentrated. Then, the biomass is sent to the stabilization reactor, where colloidal material removed from the wastewater in the contact reactor is stabilized. Stabilized biomass is returned to the contact reactor by a biomass recycle flow. A fixed film system may be defined as a modified activated sludge wastewater treatment system that utilizes microorganisms attached to an inert medium (such as rock, slag, or plastic) within the reaction vessel to remove dissolved, suspended, and colloidal biomass from wastewater. As the wastewater flows over the medium, microorganisms in the water may attach themselves to the medium and form a fixed biological film over time. This physical attachment prevents biomass washout and leads to high values of elevated reactor microorganism concentration and solids retention time. Attachment also permits fixed film reactors to operate at flow velocities that would easily washout the nonattached biomass. A plug flow system may be defined as a modified activated sludge wastewater treatment process comprising a long tank or pipe in which wastewater and returned activated sludge enter and travel through at a constant rate to the point of discharge. A plug flow reactor generally comprises long and narrow aeration basins. This causes the concentration of dissolved, suspended, and colloidal biomass to vary along the reactor length.

The systems may further comprise a sedimentation apparatus that allows wastewater and/or sludge water to clarify via the settling of dissolved, suspended, and colloidal biomass via flocculation. The settling of the dissolved, suspended, and colloidal biomass in a modified activated sludge wastewater treatment process results in clearer wastewater and/or supernatant as well as activated sludge. The system may use a sedimentation apparatus before secondary treatment or after secondary treatment. After secondary treatment, the supernatant may be treated by the disinfection apparatus to create a treated effluent, which may be removed from the wastewater treatment plant by discharging the effluent to the receiving waters. The supernatant may be treated by the disinfection apparatus using several techniques, including, but not limited to, chlorination, ozonation, and ultraviolet disinfection.

The use of the cationic clay composition during the wastewater treatment process can increase the effectiveness of treatment depending on the point at which the cationic clay composition is added to the wastewater in the treatment process. The point at which addition of the cationic clay composition to the wastewater is necessary varies by system and conditions. For instance, sometimes it may be necessary to add the cationic clay composition to wastewater immediately after collection to remove ammonia and sulfur containing compounds early in the treatment process. For instance, it may be necessary to add the cationic clay composition to the wastewater before secondary treatment or during secondary treatment. In other systems the addition of the cationic clay composition may come after preliminary treatment due to the nature of the reactor. Further, an operator may decide whether or not the cationic clay composition should be added to wastewater at certain points depending on desired results. For instance, the operator may decide to add the cationic clay composition to sludge removed from the sedimentation apparatus to create a more compact product in situations where the sludge is not sufficiently compact.

The foregoing summary has outlined some features of the process of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and process disclosed herein. Those skilled in the pertinent art should also realize that such equivalent designs or modifications do not depart from the scope of the process of the present disclosure.

### DESCRIPTON OF THE DRAWINGS

These and other features, aspects, and advantages of the present disclosure will become better understood with regard to the following description, appended claims, and accompanying drawings where:

FIG. 1 is a schematic of an activated sludge wastewater treatment in which techniques described herein may be implemented.

FIG. 2 is a schematic of an activated sludge wastewater treatment plant in which techniques described herein may be implemented.

FIG. 3 is a schematic of an activated sludge wastewater treatment plant in which techniques described herein may be implemented.

FIG. 4 is a schematic of an activated sludge wastewater treatment plant in which techniques described herein may be implemented.

FIG. 5 is a schematic of an activated sludge wastewater treatment plant in which techniques described herein may be implemented.

FIG. 6 is a schematic of an activated sludge wastewater treatment plant in which techniques described herein may be implemented.

FIG. 7 is a flow chart illustrating certain method steps of a method embodying features consistent with the principles of the present disclosure.

FIG. 8 is a flow chart illustrating certain method steps of a method embodying features consistent with the principles of the present disclosure.

FIG. 9 is a flow chart illustrating certain method steps of a method embodying features consistent with the principles of the present disclosure.

FIG. 10 is a flow chart illustrating certain method steps of a method embodying features consistent with the principles of the present disclosure.

FIG. 11 is a flow chart illustrating certain method steps of a method embodying features consistent with the principles of the present disclosure.

FIG. 12 is a flow chart illustrating certain method steps of a method embodying features consistent with the principles of the present disclosure.

### DETAILED DESCRIPTION

In the Summary above and in this Detailed Description, and the claims below, and in the accompanying drawings, reference is made to particular features, including process steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. Where reference is made herein to a process comprising two or more defined steps, the defined steps can be carried out in any order or simultaneously (except where the context excludes that possibility), and the process can include one or more other steps which are carried out before any of the defined steps, between two of the defined steps, or after all the defined steps (except where the context excludes that possibility).

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. As used herein, the term “suspended” and grammatical equivalents thereof may refer to all pollutants in wastewater regardless of form. For instance, dissolved, suspended, and colloidal biomass may be suspended in wastewater. As used herein, the term “flocculant” and grammatical equivalents thereof may refer to the substances that promote the clumping of particulate pollutants suspended within wastewater. For instance, a cationic clay composition may promote the clumping of biomass suspended throughout the wastewater to form activated sludge. As used herein, the term “sludge water” and grammatical equivalents thereof may refer to wastewater containing activated sludge.

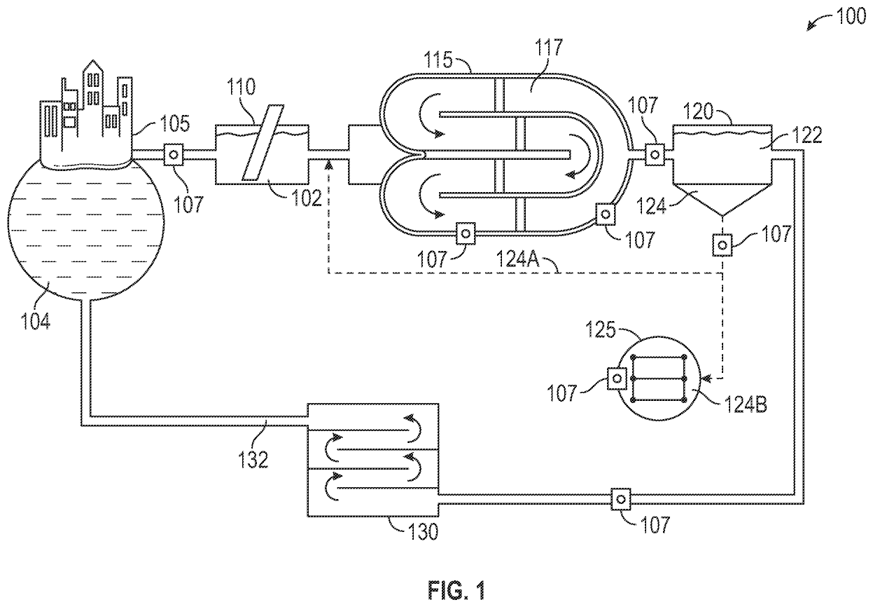

FIGS. 1-12 illustrate embodiments of various wastewater treatment systems and various methods for treating wastewater 102 using a cationic clay composition that acts as a flocculant. In some embodiments, the precipitate created by the various methods herein may be recycled. As illustrated in FIGS. 1-6, numerous systems in which the various methods herein are carried out comprise a wastewater collection apparatus 105, preliminary treatment apparatus 110, secondary treatment apparatus 115, 215, 315, 415, 515, 615, digestor apparatus 125, and disinfection apparatus 130. In an optional embodiment, the wastewater treatment systems are activated sludge 124 systems. Wastewater 102 is collected by the systems and a cationic clay composition is added to the wastewater 102 at numerous injection sites 107, which causes biomass within the wastewater 102 to flocculate out. In one optional embodiment, the systems may further comprise a sedimentation apparatus 120 (clarifier). In another optional embodiment, the system may further comprise a flow equalization apparatus. In yet another optional embodiment, the system may further comprise a denitrification apparatus. A coagulating polymer may be added to the wastewater 102 to assist the cationic clay composition in precipitating out biomass.

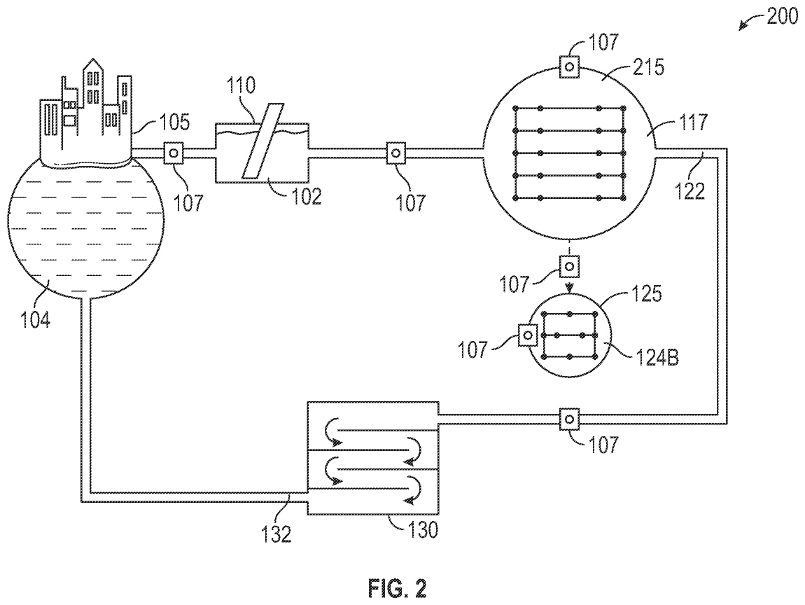

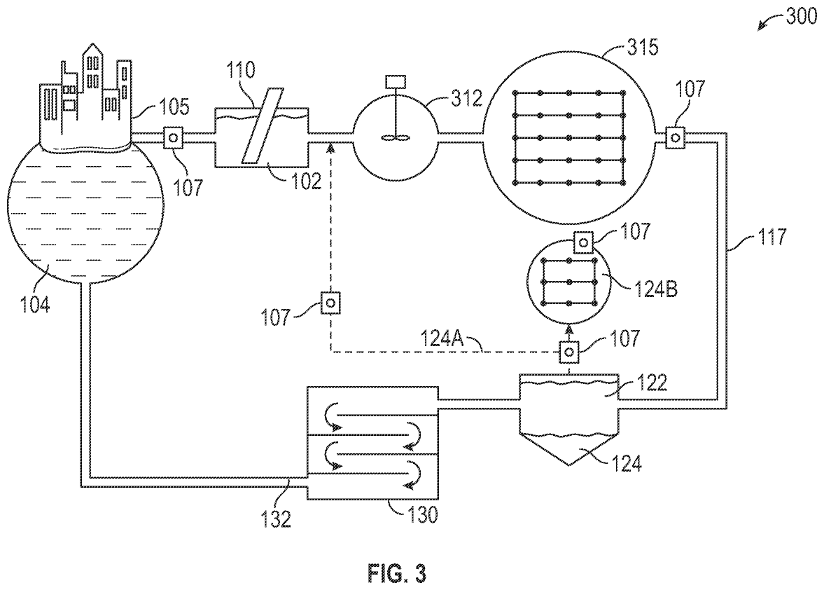

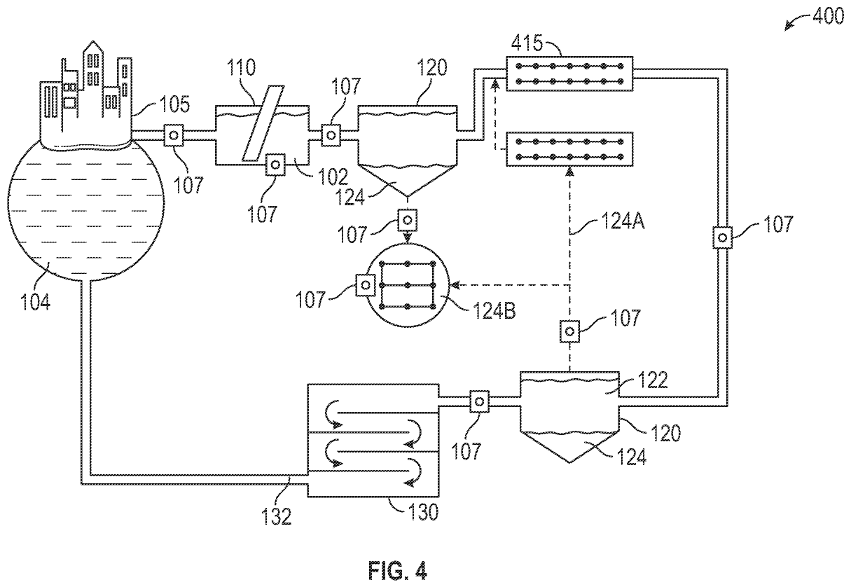

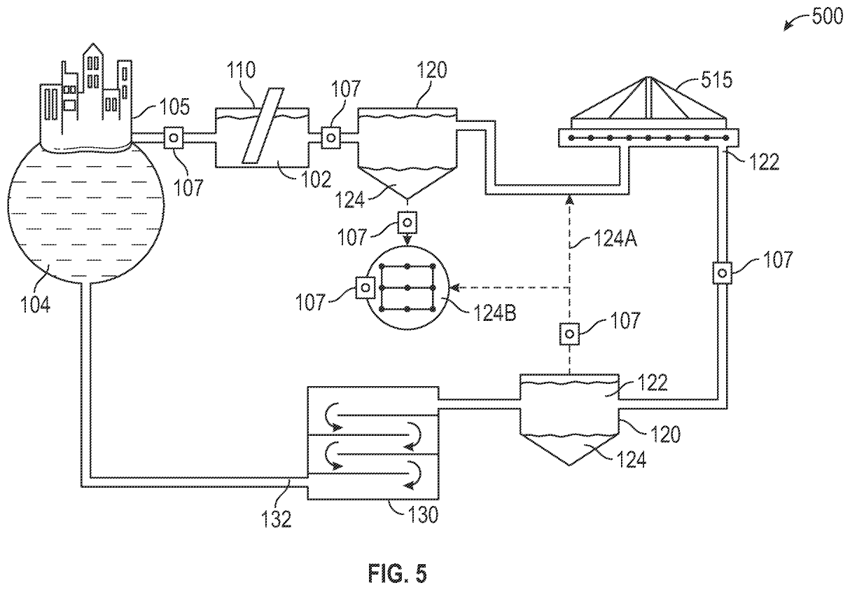

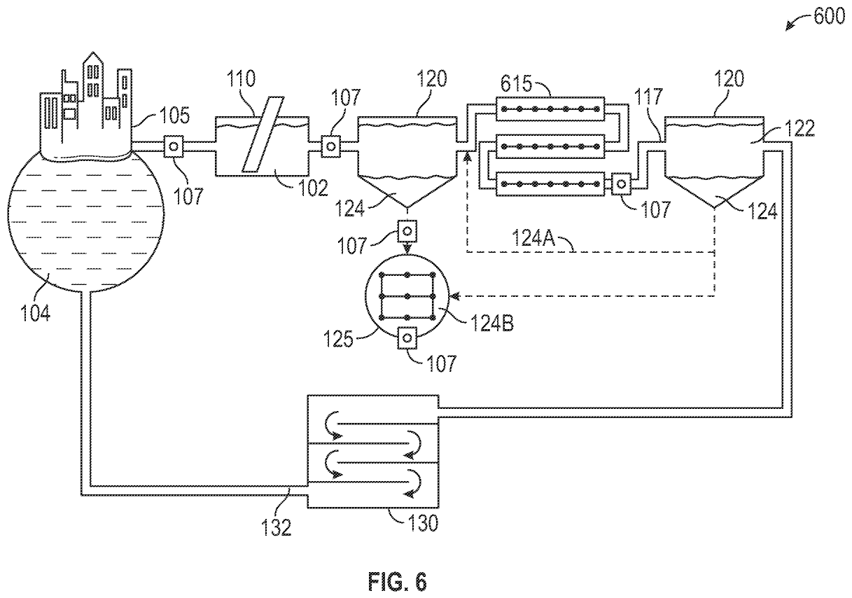

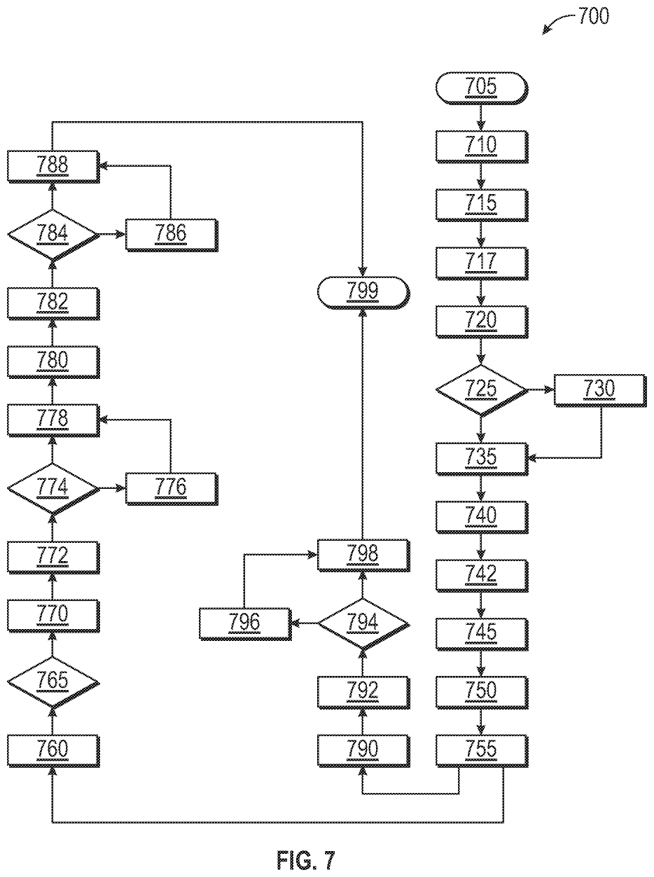

It is understood that the various method steps associated with the methods of the present disclosure may be carried out by an operator using the systems shown in FIGS. 1-6. FIG. 1 is an exemplary diagram of an oxidation ditch system 100, wherein the oxidation ditch system 100 is an activated sludge wastewater treatment plant that agitates/aerates wastewater 102 via an oxidation ditch reactor 115. FIG. 2 is an exemplary diagram of a sequence batch system 200, wherein the sequence batch system 200 is an activated sludge wastewater treatment plant that agitates/aerates wastewater 102 via a sequence batch reactor 215. FIG. 3 is an exemplary diagram of an extended aeration system 300, wherein the extended aeration system 300 is an activated sludge wastewater treatment plant that agitates/aerates wastewater 102 via an extended aeration reactor 315. FIG. 4 is an exemplary diagram of a contact stabilization system 400, wherein the contact stabilization system 400 is an activated sludge wastewater treatment plant that agitates/aerates wastewater 102 via a contact stabilization reactor 415. FIG. 5 is an exemplary diagram of a fixed film system 500, wherein the fixed film system 500 is an activated sludge wastewater treatment plant that agitates/aerates wastewater 102 via a fixed film reactor 515. FIG. 6 is an exemplary diagram of a plug flow system 600, wherein the plug flow system 600 is an activated sludge wastewater treatment plant that agitates/aerates wastewater 102 via a plug flow reactor 615. FIGS. 7-12 illustrate various methods that may be carried out by an operator using the systems of FIGS. 1-6.

Wastewater 102 may be defined as water having pollution suspend throughout. There are typically four types of pollution that may be in wastewater 102: organic, inorganic, thermal, and radioactive. Domestic wastewater 102 contains a large amount of organic waste, which is pollution that mainly comes from animal or plant sources. Bacteria and other microorganism can consume organic waste. Some industrial organic waste comes from vegetable and fruit packing, dairy processing, meatpacking, tanning, poultry oil, paper mills, wood, etc. Domestic wastewater 102 also contains inorganic materials such as sand, salt, iron, calcium, and other materials which are only slightly affected by the actions of microorganisms. Industrial wastewater 102 contains inorganic material such as heavy metals (chromium, cadmium, lead, molybdenum, etc.), gravel, and grit. The first indication that a strong toxic industrial discharge has entered the wastewater treatment plant is an increase in oxygen concentration in the aeration basin. This will happen because microorganisms have been killed resulting in no oxygen being consumed. Thermal waste is heated waste from cooling processes used by industry and thermal power stations. Radioactive waste usually comes from a controlled source, but could come from hospitals, research laboratories, toxic disposal industries, and nuclear power plants. If wastewater 102 is not treated before being transported to receiving waters 104, the organic solids may deplete oxygen supplies in the receiving waters 104, which could cause fish kills and become a source of unpleasant odors.

Wastewater can be treated by adding a flocculating compound that causes biomass suspended throughout wastewater 102 to floc out and create sludge 124. The flocculating compound mixed with the wastewater 102 to create sludge 124 is a cationic clay composition. The cationic clay composition preferably comprises at least ninety-five combined weight percent cationic clays, such as cationic phyllosilicates, and titanium dioxide when in powdered form, wherein the cationic clays make up the majority of the cationic clay composition. For instance, the cationic clay composition may comprise seventy weight percent aluminum phyllosilicates and twenty-five weight percent titanium dioxide. The cationic clay composition preferably comprises at least seventy weight percent cationic phyllosilicates and up to twenty weight percent titanium dioxide. For instance, the cationic clay composition may comprise ninety-five weight percent aluminum phyllosilicates and zero weight percent titanium dioxide. The cationic clay composition is mixed with the wastewater 102 in an amount sufficient to promote flocculation. The cationic clay composition is preferably mixed at a rate of at least 0.0025 pounds per gallon depending on the type of wastewater treatment plant, type of wastewater received (industrial or residential), and amount of biomass present within the wastewater. For instance, a wastewater treatment plant that processes 100,000 gallons of wastewater a day may use at least 250 pounds of cationic clay composition to promote flocculation. A coagulating polymer may also be mixed with the wastewater 102 to assist the cationic clay composition in precipitating out suspended biomass. In one optional embodiment, the coagulating polymer is mixed with the cationic clay composition prior to being mixed with wastewater 102. The cationic clay composition may be mixed with a volume of water to create a slurry before addition to the wastewater 102. In some instances, addition as a slurry increases the effectiveness of the cationic clay composition and decreases turbidity of the resulting sludge water 117. When mixed with water, the resulting slurry may be at least eighty weight percent cationic clays and titanium dioxide and no more than twenty weight percent water.

Wastewater 102 is collected by the wastewater collection apparatus 105 of the system. It is important that the wastewater 102 is received by the plant from the wastewater 102's point of origin quickly to prevent septic conditions. The various pipes and open channels of the wastewater collection apparatus 105 are often constructed of concrete, vitrified clay, brick, metals, and polymers. The designed flows of a wastewater collection apparatus 105 vary greatly depending on factors ranging from population, topography of the area, rainfall, etc. Generally, the hydraulic design of the wastewater collection apparatus 105 has peak flow velocities great enough to prevent sedimentation and small enough to prevent erosion. The wastewater collection apparatus 105 may comprise lateral lines, main lines, manholes, gravity sewer lines, lift stations, and force mains. All of these systems work together to provide wastewater treatment plants the wastewater 102 produced by residential, commercial, and industrial areas within the plant's jurisdiction. Some wastewater collection apparatuses 105 may also carry storm runoff Lateral lines may be defined as pipes or open channels that carry waste from residential areas and businesses. Main lines may be defined as large pipes or open channels that collect the sewage from the lateral lines. Manholes may be defined as junctions of intersecting main lines that have entry ports that allow for inspection of the wastewater collection apparatus 105. Gravity sewer lines may be defined as pipes or open channels that carry wastewater 102 collected by main lines to a lower elevation via gravity. Lift stations may be defined as wastewater collection facilities that use pumps to lift the wastewater 102 to a higher elevation or a treatment plant. Force mains may be defined as pipes or open channels used to carry wastewater 102 from a lift station to a treatment plant. When cationic clay composition is injected into wastewater during the wastewater collection, it is preferably added in powder form; however, it may be added in slurry form as well.

Once the wastewater 102 has been collected, the preliminary treatment apparatus 110 is designed to screen out large, entrained, suspended, and floating solids. These solids may include wood, cloth, paper, plastics, garbage, and fecal matter, or any combination thereof. Solids may be screened out of the wastewater 102 by passing the wastewater 102 through coarse screens and fine screens. A course screen may be defined as a mechanical filter comprising a series of parallel steel bars spaced between 1 and 3 inches apart. The bars are typically placed in a vertical position relative the flow; however, the bars may be placed at other angles. Coarse screens may be cleaned manually or may comprise automatic cleaning mechanisms. Fine screens may be defined as a mechanical filter comprising wire cloth, wedge wire elements, or perforated plates having openings generally no larger than 0.25 inches. Fine screens may be static, rotatory drum, or step, and are used to screen out solid particulates. Solids removed from the influent wastewater 102 are called screenings, which may be disposed of via incinerated or burial. In some embodiments, comminutors and grinders may be used to grind and shred solids into a smaller size. A comminutor may be defined as a slotted rotating cylinder comprising a plurality of blades that cuts up solids suspended within the wastewater 102 too large to pass through the slots. Grinders may be defined as a plurality of counterrotating intermeshing cutters that trap and shear wastewater 102 solids into a consistent particle size.

The preliminary treatment apparatus 110 may also be designed to screen out heavy inorganic matter called grit. Inorganic material that may be categorized as grit includes, but is not limited to, sand, gravel, metal, and glass, or any combination thereof. Removal of grit may be accomplished via aerated grit chambers, vortex removal, detritus tanks, horizontal flow grit chambers, and cyclonic inertial separation. An aerated grit chamber may be defined as an apparatus that causes wastewater 102 to flow in a spiral pattern by introducing air into one side of the chamber. Heavier grit particles diverge from the spiral streamline and settle at the bottom of the chamber, which may be collected at a later time. Vortex removal may be defined as a system that introduces wastewater to a tank in a tangential fashion such that a vortex is created. Gravity causes the grit to settle at the bottom of the tank and the wastewater 102 exits at the top, thus removing the grit from the wastewater 102. A detritus tank may be defined as a short-term settling tank. The wastewater 102 in the tank is kept at a constant level, and grit is removed from the bottom of the tank periodically where it is subsequently washed to remove organic matter. A horizontal flow grit chamber may be defined as a channel that allows grit to settle at the bottom and lighter particles to remain suspended in the wastewater 102. A constant upstream velocity of approximately 1 ft/sec may be used to allow settling while keeping the lighter biomass suspended. Flow rate in a horizontal flow grit chamber may be controlled via weirs or control sections. A hydrocyclone may be defined as a centrifuge designed to separate heavier grit from the lighter organic solids. Grit collects on the sides of the hydrocyclone, whereas lighter biomass may be removed from the center.

In another optional embodiment, the system may further comprise a flow equalization apparatus that controls flow velocities of wastewater 102 in a wastewater treatment plant. Flow equalization apparatuses generally comprise a tank, flow pumps, and flow controls. The flow equalization apparatus may be situated to store wastewater 102 after undergoing preliminary treatment because treatment processes generally work more efficiently if the flow rate through them is steady. The tank provides storage for wastewater 102 moving through the system. The tank is large enough to hold the wastewater 102 arriving during a peak period and release that wastewater 102 to the rest of the wastewater treatment plant via the flow pumps. The flow controls dictate the flow rate of the flow pumps. This allows a flow equalization apparatus to supply additional water to the wastewater treatment system when it is arriving less rapidly than desired and reduce the flow when wastewater is arriving more rapidly than desired. Use of a flow equalization controls the flow through each stage of the treatment system, allowing adequate time for the physical, biological and chemical processes to take place. It also prevents solids and organic material from being forced out of the treatment process during peak usage.

In yet another optional embodiment, the system may further comprise a nitrogen removal apparatus 312 that removes nitrogen compounds from the system. A nitrogen removal apparatus 312 uses both nitrification and denitrification to remove nitrogen from the system. The system used microorganisms that perform both nitrification and denitrification on nitrogen containing compounds. Nitrification is a process in which ammonia is converted to nitrates by aerobic organisms. Denitrification is a process in which nitrates are reduced to gaseous nitrogen by anaerobic organisms. Because the organisms that perform denitrification will metabolize available oxygen before nitrates, it is important that oxygen concentrations are low in order for denitrification to take place. The denitrification process also requires an appropriate amount of carbon containing compounds that may act as an energy source for the anaerobic organisms so that they may perform denitrification. As such, a nitrogen removal apparatus 312 generally comprises at least two tanks in which an aerobic zone and anaerobic zone may be implemented.

Denitrification apparatuses can have an anaerobic zone prior to an aeration zone or after an aeration zone. When wastewater 102 and sludge 124 enter a denitrification apparatus having an anoxic zone before an aeration zone, nitrate produced in the aerobic zones by nitrification is recycled back to the anoxic zones for denitrification. This process enables the use of the organic carbon source that is available in the influent for denitrification. Since nitrification is located after denitrification, nitrate is present in the effluent. Effluent produced by wastewater treatment plants having a pre-denitrification process will typically have organic nitrogen concentrations ranging from 6 to 10 mg N L⁻¹. When wastewater 102 and sludge 124 enter a denitrification apparatus having an anoxic zone before an aeration zone, self-generated endogenous organics and/or external carbon sources are used as the carbon source. The organic carbon source within the wastewater 102 is consumed in the aerobic zone. Release of ammonium in the anoxic zone may result if only self-generated endogenous organics are used as carbon sources.

After the wastewater 102 has been screened, the secondary treatment apparatus 115, 215, 315, 415, 515, 615 is designed to mix the wastewater 102 and cationic clay composition in a way such that they floc out of suspension as well as increase oxygen levels for the microorganisms within the sludge water 117 than are breaking down the biomass. Secondary treatment of the wastewater 102 with the cationic clay composition may take place in at least one of an oxidation ditch reactor 115, sequence batch reactor 215, extended aeration reactor 315, contact stabilization reactor 415, fixed film reactor 515, and plug flow reactor 615, or any combination thereof. However, other types of secondary treatment apparatuses may be used. Secondary treatment removes dissolved, suspended, and colloidal biomass that may have escaped preliminary treatment. Removal of dissolved, suspended, and colloidal biomass during secondary treatment is accomplished via microbial processes that consume the organic waste and convert it into carbon dioxide, water, and energy. Removal of the remaining organic matter during secondary treatment protects the oxygen balance of a receiving waters 104, which prevents foul odors and fish kills. The three basic biological treatment methods are trickling filter, activated sludge 124 process, and oxidation pond. The focus of the methods of the current application are on wastewater treatment systems that employ the activated sludge 124 process. When the cationic clay composition is added during agitation, it is preferably added in powder form; however, the cationic clay composition may also be added in slurry form.

The main design and operating parameters of activated sludge wastewater treatment systems include the hydraulic retention time (HRT), the sludge 124 recycle rate (r), the sludge 124 retention time (SRT), mixed liquor suspended solids (MLSS), the volumetric organic load (VOL), the food microorganism ratio (F/M), the sludge 124 settling properties (sludge 124 volumetric index (SVI)), the characteristics of floc, and the concentration of dissolved oxygen (DO). The HRT is one of the main parameters in the activated sludge 124 system as it is implicitly associated with the organic load applied and the reactor volume. The HRT affects the costs of implementation, operation, and maintenance. The VOL and F/M ratio represent the organic load applied to the system in terms of the reactor volume and the active biomass, respectively. The F/M ratio can create conditions that favor the predominance of filamentous organisms that affect the settling properties of the sludge 124, causing brown foam in the aeration tank and deterioration in effluent quality. The SRT, used for the design and operation of the system, is the most important parameter in maintaining the MLSS concentration, as it influences the evolution of the biochemical transformation processes and is related to the rate of growth of microorganisms, because only the microorganisms capable of breeding in this time can survive and enrich the system. The SRT can affect the floc structure and the settling properties of the sludge 124.

The MLSS represents the amount of biomass in the system. The SVI indicates the separation efficiency of the biomass of the mixed liquor. The settling properties of sludge 124 formed during the activated sludge 124 process are essential for the clarification of the effluent. High values of SVI are associated with sludge 124 bulking and foam problems that affect the effluent quality. The solids concentration in the secondary settler affect the solids concentration in the recirculation sludge 124, although if the sludge 124 is concentrated, the recycle rate requirements will be lower in order to guaranteed the MLSSV in the SR, which is also affected by the SRT. The DO concentration is important in the development of processes that occur in the activated sludge 124 systems. The main oxygen requirements are determined by oxidation of organic matter and ammonia through heterotrophic and autotrophic microorganisms respectively. Low levels of DO can affect the sludge 124 settling properties and the metabolic activity of microorganisms, generating an incomplete removal of substrate, which is reflected in the poor effluent quality. The biological oxygen demand (BOD) is directly related to the DO and refers to the amount of oxygen that would be consumed if all the organics in one-liter of wastewater were oxidized by bacteria and protozoa. When BOD levels are high, DO levels decrease because the oxygen that is available in the wastewater is being consumed by bacteria. Activated sludge is often returned at a rate of approximately 1,000 to 1,500 mg/L MLSS; however, this may be higher or lower depending on the number of biomass within the wastewater, HRT, SRT, and other variables.

An oxidation ditch system 100 may be defined as a modified activated sludge wastewater treatment process comprising an oxidation ditch reactor 115 as its secondary treatment apparatus that enables the system to use long solids retention times (SRTs) to remove biomass. Oxidation ditch reactors 115 typically comprise a basin having a ring, oval or horseshoe shape. This basin may have a single or multichannel configuration. Wastewater 102 is flowed through the basin and continuously recirculated, allowing some wastewater 102 to proceed to the next step in the treatment process. Mounted aerators (mechanical aerators/brushes) circulate the wastewater 102 within the basin as well as facilitate oxygen transfer and aeration. Wastewater 102 may be circulated at a rate of 0.8 to 1.2 ft/s within the oxidation ditch reactor 115. Activated sludge 124 recycle rates for an oxidation ditch reactor 115 often range from 75 to 150 percent, and the MLSS concentration often ranges from 1,500 to 5,000. An oxidation ditch typically has a solid retention time of approximately 4 to 48 days. The BOD loading rate is typically 1.6×10⁵ to 4.7×10⁷ mg/1000 liters, and the HRT range is between 6 and 30 hours.

A sequence batch system 200 may be defined as a modified activated sludge wastewater treatment process comprising at least one aeration tank (sequence batch reactor 215) as its secondary treatment apparatus that bubbles oxygen through wastewater 102 and activated sludge 124 in batches to reduce dissolved, suspended, and colloidal biomass. The cycle for each tank in a typical sequence batch system 200 is divided into five discrete periods: fill, react, settle, draw and idle, so equalization, aeration, and clarification can all be achieved using a single batch reactor 215. However, two or more batch reactors 215 may be used in sequence to optimize results. Each tank of the system is filled with a batch of wastewater 102 during a discrete period of time and then operated as a batch reactor 215. After desired treatment, the mixed liquor is allowed to settle, and the clarified supernatant 122 is then drawn from the tank. The F/M ratio of a sequence batch system 200 is typically between 0.15 to 0.6 lbs. BOD/ lb. MLSS. The treatment cycle duration ranges from 4 to 24 hours. The MLSS at low water levels ranges from approximately 2,000 to 4,000 mg/L. The HRTs range from 6 to 14 hours; however, HRTs may be longer or shorter depending on the application.

An extended aeration system 300 may be defined as a modified activated sludge wastewater treatment process comprising at least one aeration tank (extended aeration reactor 315) as its secondary treatment apparatus designed to reduce dissolved, suspended, and colloidal biomass under aerobic conditions. Oxygen required to sustain the aerobic biological processes may be supplied by mechanical means or diffusion means. Mixing must be provided by aeration or mechanical means to ensure the microorganisms remain in contact with the dissolved, suspended, and colloidal biomass. It is important that the pH is controlled in extended aeration systems 300 to optimize the biological process. It is also important that carbon is available to the microorganisms to facilitate biological growth and the reduction of biomass. Flow rates typical to an extended aeration system 300 are between 0.002 to 0.1 million gallons per day. Extended aeration systems 300 are similar to plug flow systems 600 in design; however, the aeration tanks in extended aeration systems 300 are larger to provide HRTs ranging from 18 to 30 hours or more. The F/M of an extended aeration system 300 is typically between 0.05 to 0.15 lbs. BOD/lb. MLSS. The MLSS levels range from approximately 2,000 to 6,000 mg/L. The SRT in an extended aeration system 300 typically ranges from 20 to 30 days.

A contact stabilization system 400 may be defined as a modified activated sludge wastewater treatment process comprising a contact reactor and a stabilization reactor separated by a sedimentation tank. The contact reactor receives the wastewater 102 and the biomass in a starved condition so that soluble material is readily adsorbed by the starved biomass. The mixed liquor leaving the contact reactor is settled and the biomass is concentrated. Then, the biomass is sent to the stabilization reactor, where colloidal material removed from the wastewater 102 in the contact reactor is stabilized. Stabilized biomass is returned to the contact reactor by a biomass recycle flow. For the contact reactor, the HRT varies between 0.5 and 1.5 hours. For the stabilization reactor, the HRT is determined by the recycle rate (flow recirculation) and can vary between 2 and 6 hours. The recommended concentrations of MLSS for the contact stabilization process are between 1000 and 3000 mg L⁻¹ for the contact reactor, and between 4000 and 10000 mg L⁻1 for the stabilization reactor. The fraction of biomass in the contact reactor is called the sludge distribution fraction (a factor), and values recommended are between 0.1 and 0.3. The SRT in contact stabilization system 400 typically ranges from 5 to 15 days.

A fixed film system 500 may be defined as a modified activated sludge wastewater treatment system that utilizes microorganisms attached to an inert medium (such as rock, slag, or plastic) within the reaction vessel to remove dissolved, suspended, and colloidal biomass from wastewater 102. As the wastewater 102 flows over the medium, microorganisms in the wastewater may attach themselves to the medium and form a fixed biological film (also known as a zoogleal mass) over time. This physical attachment prevents biomass washout and leads to high values of elevated reactor microorganism concentration and solids retention time. Attachment also permits fixed film reactors 515 to operate at flow velocities that would easily washout the nonattached biomass. The fixed film may comprise bacteria (aerobic, anaerobic, and facultative), fungi, algae, and protozoa. The dissolved, suspended, and colloidal biomass may then be degraded by the various microorganisms in the outer part of the film. As the layer thickens through microbial growth anaerobic organisms develop in the inner portion of the film, allowing the film to perform both aerobic and anaerobic processes. In an optional embodiment, the fixed film is between 0.1 and 0.2 mm thick.

A plug flow system 600 may be defined as a modified activated sludge wastewater treatment process comprising a tank or pipe (plug flow reactor 615) as its secondary treatment apparatus in which wastewater 102 and returned activated sludge 124 enter and travel through at a constant rate to the point of discharge. A plug flow reactor 615 generally comprises long and narrow aeration basins. This causes the concentration of dissolved, suspended, and colloidal biomass to vary along the reactor length. Aeration may take place along the length of the plug flow reactor 615 or only take place along a portion of the plug flow reactor 615. In an optional embodiment, aeration takes place in an early portion of the plug flow reactor 615. Wastewater 102 flows in one direction. There is no flow equalization or mixing from multiple time periods in a plug flow system 600. The F/M ratio of a plug flow system 600 is typically between 0.2 to 0.4 lbs. BOD/ lb. MLSS. The MLSS levels range from approximately 1,500 to 3,000 mg/L. The HRTs range from 4 to 8 hours. The SRTs in a plug flow system 600 typically range from 5 to 15 days but may be more or less depending on conditions.

In one optional embodiment, the system may further comprise a sedimentation apparatus 120 that allows wastewater 102 and/or sludge water 117 to clarify via the settling of dissolved, suspended, and colloidal biomass. The settling of the dissolved, suspended, and colloidal biomass in a modified activated sludge wastewater treatment process results in clearer effluent 102 and/or supernatant 122 as well as activated sludge 124. The system may use a sedimentation apparatus 120 before secondary treatment to remove as much settable and floatable material as possible from wastewater 102. The system may also use a sedimentation apparatus 120 after secondary treatment to produce a clear supernatant 122 that may undergo disinfection and ultimately discharge in the receiving waters 104. The activated sludge 124 that settles at the bottom of the sedimentation apparatus 120 may be reused in the activated sludge 124 process to provide food to the microorganisms of the system. Alternatively, the activated sludge 124 may be wasted via digestion and ultimately removed from the wastewater treatment system.

After secondary treatment, the supernatant 122 may be treated by the disinfection apparatus 130 to create a treated effluent 132, which may be removed from the wastewater treatment plant by returning the treated effluent 132 to the receiving waters 104. The supernatant 122 may be treated by the disinfection apparatus 130 using several techniques, including, but not limited to, chlorination, ozonation, and ultraviolet disinfection. In an optional embodiment, treatment of wastewater 102 via chlorine is used because it can be supplied in many forms (chlorine gas, hypochlorite solutions, and other solid or liquid chlorine compounds), is more cost effective than other disinfection methods, has a flexible dosing control, and can eliminate noxious odors. In an optional embodiment of a disinfection apparatus 130 that disinfects via chlorination, the disinfection apparatus may comprise a chlorine diffuser, contact basin, and dechlorination diffuser (typically using sulfur dioxide). The supernatant 122 and chlorine gas are mixed at the chlorine diffuser before flow through the contact basin. In an optional embodiment, the contact basin is designed such that there are no flow dead zones. Once the chlorinated supernatant 122 reaches the end of the contact basin, the dechlorination diffuser may be used to mix sulfur dioxide, sodium bisulfate, and/or sodium metabisulfite with the chlorinated supernatant 122 to remove any residual chlorine and produce treated effluent 132 that may be safely released to the receiving waters 104.

TABLE 1
Biosolid elemental composition per kilogram of activated sludge.

| | | Before treatment | After treatment |
|---|---|---|---|
| | | with cationic | with cationic |
| Analyte | Unit | clay composition | clay composition |
| Arsenic | mg/Kg | 4.8 | 5.8 |
| Cadmium | mg/Kg | 1.2 | 1.3 |
| Copper | mg/Kg | 250 | 250 |
| Lead | mg/Kg | 19 | 26 |
| Mercury | mg/Kg | 0.34 | 0.31 |
| Molybdenum | mg/Kg | 42 | 35 |
| Nickel | mg/Kg | 120 | 73 |
| Nitrogen, Total | % | 3.1 | 6.4 |
| Phosphorus, Total | % | 4.4 | 1.7 |
| Potassium | % | 0.28 | 0.18 |
| Selenium | mg/Kg | 7.3 | 8.2 |
| Zinc | mg/Kg | 1600 | 1300 |

Use of the cationic clay composition in modified activated sludge wastewater treatment plants in the manners described herein has resulted in lower levels of problem pollutants (such as phosphates and molybdenum) while maintaining acceptable levels of pollutants already handled well by most wastewater treatment plants. Table 1 illustrates the various components of activated sludge 124 produced by a modified activated sludge wastewater treatment plant before using the cationic clay composition and after using the cationic clay composition. The significant reduction in phosphorus compounds after treatment with the cationic clay composition is particularly useful for wastewater treatment plants that handle large amounts of residential waste since phosphorus is a common pollutant of residential wastewater 102 that can often be difficult to lower to acceptable levels. Failure to lower phosphorus levels in wastewater 102 prior to release to the receiving waters 104 can result in algae blooms that can cause detrimental health affects to those who come into contact with the algae. The reduction in molybdenum after treatment with the cationic clay composition is particularly useful for wastewater treatment plants that handle large amounts of industrial waste since molybdenum can also be a pollutant in which it can be difficult to lower to acceptable levels. Failure to lower molybdenum levels in wastewater 102 prior to release to the receiving waters 104 can result in a buildup of the element over time, which can be particularly toxic to plants and animals of the environment.

FIG. 7 provides a flow chart 700 illustrating certain method steps that may be used to carry out the process of treating wastewater 102 in a system comprising an oxidation ditch reactor 115, as illustrated in FIG. 1, using the various injection sites 107. Step 705 indicates the beginning of the method. During step 710, an operator may obtain a cationic clay composition that may be used to flocculate out biomass suspended in wastewater 102. During step 715, the operator may obtain a coagulating polymer that may be used to create a precipitate in conjunction with the cationic clay composition. Wastewater 102 may then be collected by the wastewater collection apparatus 105 during step 717, and the operator may decide whether it is necessary to add the cationic clay composition to the wastewater 102 during step 720. The operator may take an action based on this determination during step 725. If the operator determines that it is not necessary to add the cationic clay composition to the wastewater 102, the operator may proceed to step 735. If the operator determines it is necessary to add the cationic clay composition to the wastewater 102, the operator may proceed to step 730, wherein the operator may add the cationic clay composition to the wastewater 102 after collection. Reasons an operator may want to add the cationic clay composition to wastewater 102 after collection in an oxidation ditch system 100 includes reducing ammonia compounds earlier in the treatment process. This in turn reduces hydrogen sulfide, which could result in less infrastructure corrosion. Additionally, introduction of the cationic clay composition at this point may reduce the number of large solids suspended in the wastewater 102, thus increasing the effectiveness of preliminary treatment and reducing the need for maintenance. Once the cationic clay composition has been added to the wastewater 102, the method may proceed to step 735.

After collection, the wastewater 102 may be screened by the preliminary treatment apparatus 110 during step 735. The wastewater 102 may then be agitated via the oxidation ditch reactor 115 during step 740, and the operator may add the cationic clay composition to the wastewater 102 during step 742 to create sludge water 117. Addition of the cationic clay composition to wastewater 102 during secondary treatment increases the settling of biomass while being agitated within the oxidation ditch reactor 115. This reduces the turbidity of the wastewater 102 before clarification and may reduce the amount of chlorine necessary to treat the supernatant 122 during the disinfection process due to lower amounts of biomass in the supernatant 122. In some optional embodiments, the coagulating polymer may be added at this point to further increasing the settling of biomass. Once agitated, the sludge water 117 may be clarified during step 745 such that the cationic clay composition and biomass floc out of the sludge water 117, thus creating a clear supernatant 122 and activated sludge 124. During step 750, the operator may add the coagulating polymer to the sludge water 117 within the clarifier to help the cationic clay composition to floc out the biomass within the sludge water 117. In some optional embodiments, the operator may add the cationic clay composition during clarification to prevent ashing (floating biomass) within the clarifier, resulting in an even clearer supernatant 122 and further reducing the amount of chlorine needed for disinfection. Alternatively, an operator may skip addition of either the coagulating polymer or cationic clay composition to the sludge water 117 within the clarifier. The activated sludge 124 may be collected by the operator and the supernatant 122 siphoned off and sent to disinfection during step 755. The method may then proceed to steps 760 and 790.

The operator may determine whether it is necessary to return a portion of the activated sludge 124 to the wastewater 102 before secondary treatment during step 760. The operator may take an action based on this determination during step 765. If the operator determines that it is not necessary to return activated sludge 124 to the wastewater 102 prior to secondary treatment, the operator may proceed to step 780. If the operator determines it is necessary to return a portion of the activated sludge 124 to the wastewater 102 prior to secondary treatment, the operator may proceed to step 770, wherein the operator may collect the activated sludge 124 to be returned to the wastewater 102. The operator may decide whether it is necessary to add the cationic clay composition to the returning activated sludge 124A during step 772. The operator may take an action based on this determination in step 774. If the operator determines that it is not necessary to add the cationic clay composition to the returning activated sludge 124A, the operator may proceed to step 778. If the operator determines it is necessary to add the cationic clay composition to the returning activated sludge 124A, the operator may proceed to step 776, wherein the operator may add the cationic clay composition to the returning activated sludge 124A. Reasons an operator may want to add the cationic clay composition to the returning activated sludge 124A in an oxidation ditch system 100 includes controlling odor and reducing the need for coagulating polymer. It may also reduce the need to centrifuge the returning activated sludge 124A by increasing the number of quality biosolid and reducing the number of decants due to a higher amount of oxygen dissolved in the wastewater 102. The operator may add the returning activated sludge 124A to the wastewater 102 during step 778. Once a portion of the activated sludge 124 has been added to the wastewater 102, the operator may proceed to steps 780.

During step 780, the oxidation ditch system 100 may digest any activated sludge 124 that was not returned to the wastewater 102. The operator may decide whether it is necessary to add the cationic clay composition to the wasted activated sludge 124B during step 782. The operator may take an action based on this determination in step 784. If the operator determines that it is not necessary to add the cationic clay composition to the wasted activated sludge 124B, the operator may proceed to step 788. If the operator determines it is necessary to add the cationic clay composition to the wasted activated sludge 124B, the operator may proceed to step 786, wherein the operator may add the cationic clay composition to the wasted activated sludge 124B. Reasons an operator may want to add the cationic clay composition to the wasted activated sludge 124B during digestion includes reducing the need to centrifuge the wasted activated sludge 124B by increasing the number of quality biomass and reducing the number of decants due to a higher amount of oxygen dissolved in the wastewater 102. This should result in a decrease in cost to digest the biomass compared to current methods. The operator may remove the wasted activated sludge 124B from the oxidation ditch system 100 after digestion during step 788. Once the wasted activated sludge 124B has been removed from the oxidation ditch system 100, the method may proceed to the terminate method step 799.

During step 790, the supernatant 122 siphoned off during step 755 may be disinfected by the disinfection apparatus 130 to create treated effluent 132. The operator may determine whether to add the cationic clay composition to the supernatant 122 within the disinfection apparatus 130 during step 792. The operator may take an action based on this determination in step 794. If the operator determines that it is not necessary to add the cationic clay composition to the supernatant 122 within the disinfection apparatus 130, the operator may proceed to step 798. If the operator determines it is necessary to add the cationic clay composition to the supernatant 122 within the disinfection apparatus 130, the operator may proceed to step 796, wherein the operator may add the cationic clay composition to the supernatant 122 within the disinfection apparatus 130. Reasons an operator may want to add the cationic clay composition to the supernatant 122 within the disinfection apparatus 130 includes further decreasing chlorine usage for disinfection and decreased turbidity, which may further lower/decrease the costs of operation. The treated effluent 132 may then be added to the receiving waters 104 during step 798. Once the treated effluent has been added to the receiving waters 104, the method may proceed to the terminate method step 799.

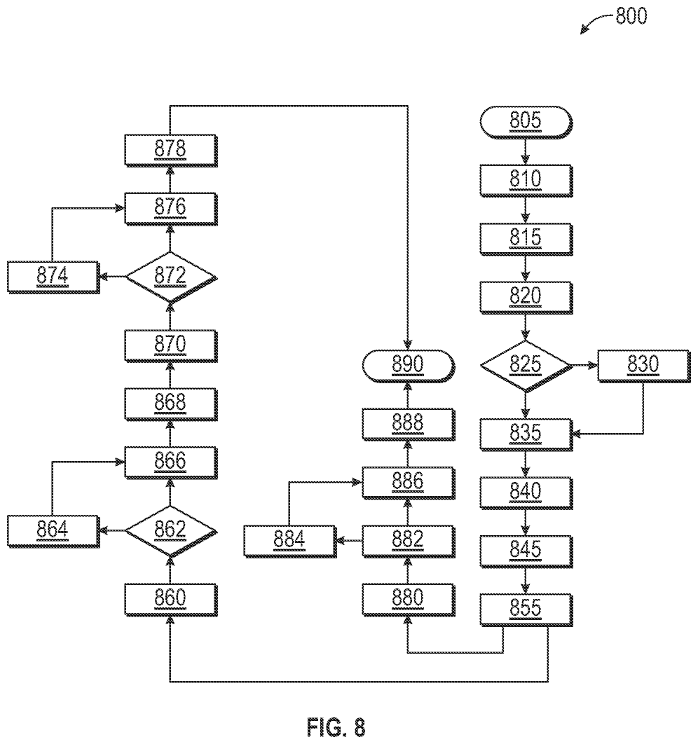

FIG. 8 provides a flow chart 800 illustrating certain method steps that may be used to carry out the process of treating wastewater 102 in a system comprising a sequence batch reactor 215, as illustrated in FIG. 2, using the various injection sites 107. Step 805 indicates the beginning of the method. During step 810, an operator may obtain a cationic clay composition that may be used to floc out biomass within wastewater 102. During step 815, the operator may obtain a coagulating polymer that may be used to create a precipitate in conjunction with the cationic clay composition. Wastewater 102 may then be collected by the wastewater collection apparatus 105, and the operator may decide whether it is necessary to add the cationic clay composition to the wastewater 102 during step 820. The operator may take an action based on this determination during step 825. If the operator determines that it is not necessary to add the cationic clay composition to the wastewater 102, the operator may proceed to step 835. If the operator determines it is necessary to add the cationic clay composition to the wastewater 102, the operator may proceed to step 830, wherein the operator may add the cationic clay composition to the wastewater 102 after collection. Reasons an operator may want to add the cationic clay composition to wastewater 102 after collection in a sequence batch system 200 includes reducing ammonia compounds earlier in the treatment process. This in turn reduces hydrogen sulfide, which could result in less infrastructure corrosion. Additionally, introduction of the cationic clay composition at this point may reduce the number of large solids suspended in the wastewater 102, thus increasing the effectiveness of preliminary treatment and reducing the need for maintenance. Once the cationic clay composition has been added to the wastewater 102, the method may proceed to step 835.

After collection, the wastewater 102 may be screened by the preliminary treatment apparatus 110 during step 835. The wastewater 102 may then be agitated via the sequence batch reactor 215 during step 840, and the operator may add the cationic clay composition to the wastewater 102 during step 845 to create sludge water 117. Addition of the cationic clay composition to wastewater 102 to create sludge water 117 within a sequence batch reactor 215 promotes the settling out of biomass to create the activated sludge 124. The addition may also promote the settling out straggler biomass still suspended in any supernatant 122 just prior to leaving the sequence batch reactor 215. This reduces the turbidity of the resulting supernatant 122 before sanitation and may reduce the amount of chlorine necessary to treat the supernatant 122 during the disinfection process due to lower amounts of biomass suspended within the supernatant 122. In some optional embodiments, the coagulating polymer may be added to the sludge water 117 within the sequence batch reactor 215 to further promote the settling of floc to create activated sludge 124 and supernatant 122. The activated sludge 124 may be collected by the operator and the supernatant 122 siphoned off and sent to disinfection during step 855. The method may then proceed to steps 860 and 880.

During step 860, the operator may decide whether it is necessary to add the cationic clay composition to the activated sludge 124 prior to digestion. The operator may take an action based on this determination during step 862. If the operator determines that it is not necessary to add the cationic clay composition to the activated sludge 124, the operator may proceed to step 866. If the operator determines it is necessary to add the cationic clay composition to the activated sludge 124, the operator may do so in step 864. Reasons an operator may want to add the cationic clay composition to the activated sludge 124 after prior to digestion includes obtaining biosolid quality sludge 124 without the need of centrifuging. It may also reduce the amount of coagulating polymer required to achieve biosolid quality sludge 124, reducing the overall cost of digestion. Additionally, introduction of the cationic clay composition at this point may increase the holding time of the activated sludge 124, which may assist in reducing the overall transportation costs of disposal. Once the cationic clay composition has been added to the activated sludge 124, the method may proceed to step 866, wherein the operator may add the coagulating polymer to the activated sludge 124. The activated sludge 124 may then be digested during step 868, and the operator may decide whether it is necessary to add the cationic clay composition to the digestion process during step 870.

During step 872, the operator may take an action based on the determination of step 870. If the operator determines that it is not necessary to add the cationic clay composition to the digestion process, the operator may proceed to step 876. If the operator determines it is necessary to add the cationic clay composition to the activated sludge 124 during digestion, the operator may proceed to step 874, wherein the operator may add the cationic clay composition to the activated sludge 124. Reasons for adding the cationic clay composition to the activated sludge 124 undergoing digestion include the same reasons one might add the cationic clay composition prior to digestion. The operator may remove the activated sludge 124 from the sequence batch system 200 after digestion during step 876. Once the sludge 124 has been removed from the sequence batch system 200, the operator may dispose of the sludge 124 during step 878. Once the wasted activated sludge 124B has been disposed of, the method may proceed to the terminate method step 890.

During step 880, the supernatant 122 siphoned off during step 855 may be disinfected by the disinfection apparatus 130 to create treated effluent 132. The operator may determine whether to add the cationic clay composition to the supernatant 122 within the disinfection apparatus 130 during step 882. The operator may take an action based on this determination in step 884. If the operator determines that it is not necessary to add the cationic clay composition to the supernatant 122 within the disinfection apparatus 130, the operator may proceed to step 888. If the operator determines it is necessary to add the cationic clay composition to the supernatant 122 within the disinfection apparatus 130, the operator may proceed to step 886, wherein the operator may add the cationic clay composition to the supernatant 122 within the disinfection apparatus 130. Reasons an operator may desire to add the cationic clay composition to the supernatant 122 within the disinfection apparatus 130 includes further decreasing chlorine usage for disinfection and decreased turbidity, which may further decrease the costs of operation. The treated effluent 132 may then be added to the receiving waters 104 during step 888. Once the treated effluent has been added to the receiving waters 104, the method may proceed to the terminate method step 890.

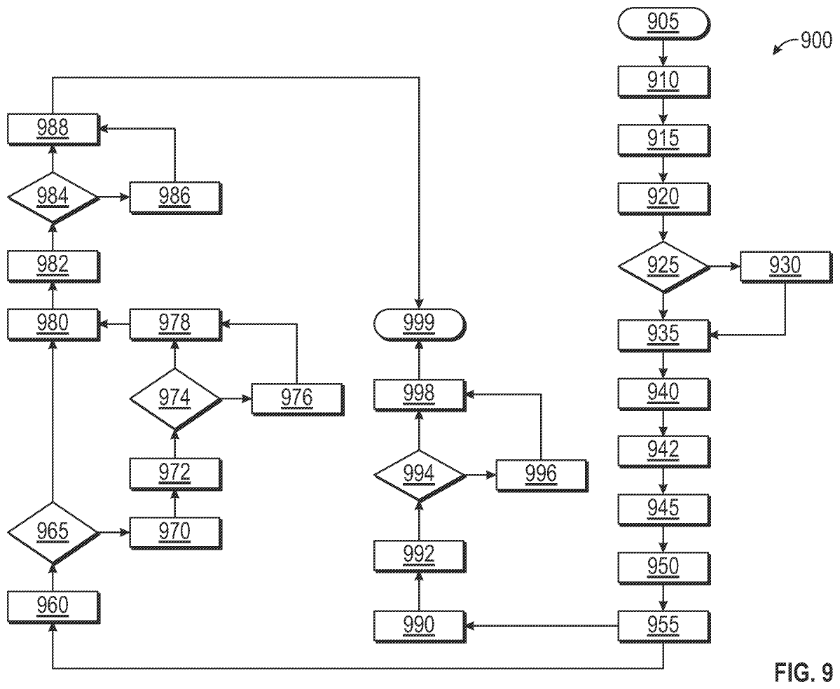

FIG. 9 provides a flow chart 900 illustrating certain method steps that may be used to carry out the process of treating wastewater 102 in a system comprising an extended aeration reactor 315, as illustrated in FIG. 3, using the various injection sites 107. Step 905 indicates the beginning of the method. During step 910, an operator may obtain a cationic clay composition that may be used to floc out biomass within wastewater 102. During step 915, the operator may obtain a coagulating polymer that may be used to create a precipitate in conjunction with the cationic clay composition. Wastewater 102 may then be collected by the wastewater collection apparatus 105, and the operator may decide whether it is necessary to add the cationic clay composition to the wastewater 102 during step 920. The operator may take an action based on this determination during step 925. If the operator determines that it is not necessary to add the cationic clay composition to the wastewater 102, the operator may proceed to step 935. If the operator determines it is necessary to add the cationic clay composition to the wastewater 102, the operator may proceed to step 930, wherein the operator may add the cationic clay composition to the wastewater 102 after collection. Reasons an operator may want to add the cationic clay composition to wastewater 102 after collection in an extended aeration system 300 includes reducing ammonia compounds earlier in the treatment process. This in turn reduces hydrogen sulfide gas, which could result in less infrastructure corrosion. Additionally, introduction of the cationic clay composition at this point may reduce the number of large solids suspended in the wastewater 102, thus increasing the effectiveness of preliminary treatment and reducing the need for maintenance. Once the cationic clay composition has been added to the wastewater 102, the method may proceed to step 935.

After collection, the wastewater 102 may be screened by the preliminary treatment apparatus 110 during step 935. In some optional embodiments, the wastewater 102 may be stored within a flow equalization tank and/or undergo anoxic denitrification immediately after undergoing screening, as is illustrated in FIG. 3. After screening, the wastewater 102 may then be aerated via the extended aeration apparatus during step 940, and the operator may add the cationic clay composition to the wastewater 102 undergoing extended aeration during step 942 to create sludge water 117. Addition of the cationic clay composition to wastewater 102 undergoing aeration prevents colloidal particles from escaping the weir wall (which if escaped, may increase turbidity and increase the colloids suspended therein), and reduces the number of biomass suspended therein. Addition of cationic clay composition may also reduce the amount of chlorine necessary to treat the supernatant 122 during the disinfection process. In some optional embodiments, the coagulating polymer may be added at this point to further increase settling of biomass.

Once aerated, the sludge water 117 may be clarified during step 945 such that the cationic clay composition and biomass floc out of the sludge water 117, thus creating a clear supernatant 122 and activated sludge 124. During step 950, the operator may add the coagulating polymer to the sludge water 117 within the clarifier to help the cationic clay composition to floc out the biomass within the sludge water 117. In some optional embodiments, the operator may add the cationic clay composition during clarification to prevent ashing within the clarifier, resulting in an even clearer supernatant 122 and further reducing the amount of chlorine needed for disinfection. Alternatively, an operator may skip the addition of either the coagulating polymer or cationic clay composition to the sludge water 117 within the clarifier. The activated sludge 124 may be collected by the operator and the supernatant 122 siphoned off and sent to disinfection during step 955. The method may then proceed to steps 960 and 990.

The operator may determine whether it is necessary to return a portion of the activated sludge 124 to the wastewater 102 before aeration during step 960. The operator may take an action based on this determination during step 965. If the operator determines that it is not necessary to return activated sludge 124 to the wastewater 102 prior to aeration, the operator may proceed to step 980. If the operator determines it is necessary to return a portion of the activated sludge 124 to the wastewater 102 prior to aeration, the operator may proceed to step 970, wherein the operator may collect the activated sludge 124 to be returned to the wastewater 102. The operator may decide whether it is necessary to add the cationic clay composition to the returning activated sludge 124A during step 972. The operator may take an action based on this determination in step 974. If the operator determines that it is not necessary to add the cationic clay composition to the returning activated sludge 124A, the operator may proceed to step 978. If the operator determines it is necessary to add the cationic clay composition to the returning activated sludge 124A, the operator may proceed to step 976, wherein the operator may add the cationic clay composition to the returning activated sludge 124A. Reasons an operator may want to add the cationic clay composition to the returning activated sludge 124A in an extended aeration system 300 includes controlling odor and reducing the need for coagulating polymer. It may also reduce the need to centrifuge the returning activated sludge 124A by increasing the biomass quality and decreasing the number of decants due to a higher amount of oxygen dissolved in the wastewater 102. The operator may add the returning activated sludge 124A to the wastewater 102 during step 978. Once a portion of the activated sludge 124 has been added to the wastewater 102, the operator may proceed to steps 980.

During step 980, the extended aeration system 300 may digest any activated sludge 124 that was not returned to the wastewater 102. The operator may decide whether it is necessary to add the cationic clay composition to the wasted activated sludge 124B during step 982. The operator may take an action based on this determination in step 984. If the operator determines that it is not necessary to add the cationic clay composition to the wasted activated sludge 124B, the operator may proceed to step 988. If the operator determines it is necessary to add the cationic clay composition to the wasted activated sludge 124B, the operator may proceed to step 986, wherein the operator may add the cationic clay composition to the wasted activated sludge 124B. Reasons an operator may want to add the cationic clay composition to the wasted activated sludge 124B during digestion includes reducing the need to centrifuge the wasted activated sludge 124B by increasing the number of quality biomass and reducing the number of decants due to a higher amount of oxygen dissolved in the wastewater 102. This should result in a decrease in cost to digest the biomass compared to current methods. The operator may remove the wasted activated sludge 124B from the extended aeration system 300 after digestion during step 988. Once the wasted activated sludge 124B has been removed from the extended aeration system 300, the method may proceed to the terminate method step 999.

During step 990, the supernatant 122 siphoned off during step 955 may be disinfected by the disinfection apparatus 130 to create treated effluent 132. The operator may determine whether to add the cationic clay composition to the supernatant 122 within the disinfection apparatus 130 during step 992. The operator may take an action based on this determination in step 984. If the operator determines that it is not necessary to add the cationic clay composition to the supernatant 122 within the disinfection apparatus 130, the operator may proceed to step 998. If the operator determines it is necessary to add the cationic clay composition to the supernatant 122 within the disinfection apparatus 130, the operator may proceed to step 996, wherein the operator may add the cationic clay composition to the supernatant 122 within the disinfection apparatus 130. Reasons an operator may want to add the cationic clay composition to the supernatant 122 within the disinfection apparatus 130 includes further decreasing chlorine usage for disinfection and decreased turbidity, which may further decrease the costs of operation. The treated effluent 132 may then be added to the receiving waters 104 during step 998. Once the treated effluent has been added to the receiving waters 104, the method may proceed to the terminate method step 999.

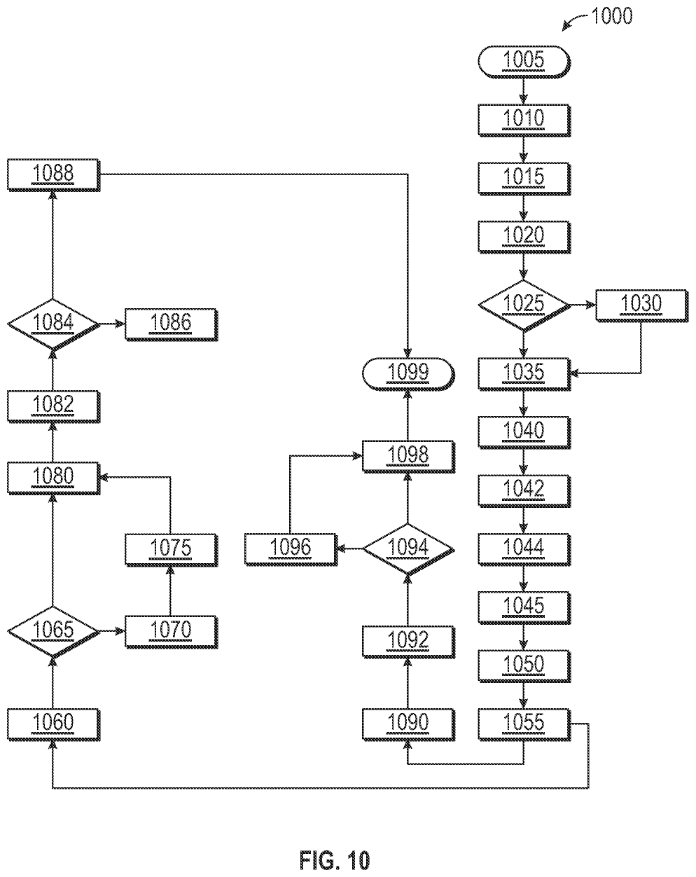

FIG. 10 provides a flow chart 1000 illustrating certain method steps that may be used to carry out the process of treating wastewater 102 in a system comprising a contact stabilization reactor 415, as illustrated in FIG. 4, using the various injection sites 107. Step 1005 indicates the beginning of the method. During step 1010, an operator may obtain a cationic clay composition that may be used to floc out biomass within wastewater 102. During step 1015, the operator may obtain a coagulating polymer that may be used to create a precipitate in conjunction with the cationic clay composition. Wastewater 102 may then be collected by the wastewater collection apparatus 105, and the operator may decide whether it is necessary to add the cationic clay composition to the wastewater 102 during step 1020. The operator may take an action based on this determination during step 1025. If the operator determines that it is not necessary to add the cationic clay composition to the wastewater 102, the operator may proceed to step 1035. If the operator determines it is necessary to add the cationic clay composition to the wastewater 102, the operator may proceed to step 1030, wherein the operator may add the cationic clay composition to the wastewater 102 after collection. Reasons an operator may want to add the cationic clay composition to wastewater 102 after collection in a contact stabilization system 400 includes reducing ammonia compounds earlier in the treatment process. This in turn reduces hydrogen sulfide, which could result in less infrastructure corrosion. Additionally, introduction of the cationic clay composition at this point may reduce the number of large solids suspended in the wastewater 102, thus increasing the effectiveness of preliminary treatment and reducing the need for maintenance. Further, introduction of the cationic clay composition at this point may assist in odor control throughout the treatment process. Once the cationic clay composition has been added to the wastewater 102, the method may proceed to step 1035.

After collection, the wastewater 102 may be screened by the preliminary treatment apparatus 110 during step 1035. After screening, the wastewater 102 may be clarified during step 1040 such that the cationic clay composition and biomass floc out of the sludge water 117. In some optional embodiments, the operator may add the coagulating polymer to the wastewater 102 within the clarifier to help the cationic clay composition floc out the biomass suspended throughout the wastewater 102. In other optional embodiments, the operator may add the cationic clay composition during clarification to prevent ashing within the clarifier, resulting in higher quality wastewater 102 and reducing the amount of chlorine needed for disinfection. Alternatively, an operator may skip the addition of either the coagulating polymer or cationic clay composition to the sludge water 117 within the clarifier. After clarification, the clarified wastewater 102 may then be agitated via the contact stabilization reactor 415 during step 1042, and the operator may add the cationic clay composition to the wastewater 102 leaving the contact reactor during step 1044 to create sludge water 117. Addition of the cationic clay composition to wastewater 102 leaving the contact reactor decreases turbidity, reducing the amount of chlorine necessary to treat the supernatant 122 during the disinfection process and makes sludge 124 more compact. This may also make the activated sludge 124 more compact and make it higher quality, meaning a higher quality mixed liquor may be made from the activated sludge 124.

After addition of the cationic clay composition, the sludge water 117 may be clarified during step 1045 such that the cationic clay composition and biomass floc out of the sludge water 117, thus creating a clear supernatant 122 and activated sludge 124. During step 1050, the operator may add the coagulating polymer to the sludge water 117 within the clarifier to help the cationic clay composition floc out the biomass within the sludge water 117. In some optional embodiments, the operator may add the cationic clay composition during clarification to prevent ashing within the clarifier, resulting in an even clearer supernatant 122 and further reducing the amount of chlorine needed for disinfection. Alternatively, an operator may skip the addition of either the coagulating polymer or cationic clay composition to the sludge water 117 within the clarifier. The activated sludge 124 may be collected by the operator and the supernatant 122 siphoned off and sent to disinfection during step 1055. The method may then proceed to steps 1060 and 1090.

The operator may determine whether it is necessary to return a portion of the activated sludge 124 to the stabilization tank during step 1060. The operator may take an action based on this determination during step 1065. If the operator determines that it is not necessary to return activated sludge 124 to the stabilization tank, the operator may proceed to step 1080. If the operator determines it is necessary to return a portion of the activated sludge 124 to the stabilization tank, the operator may proceed to step 1070, wherein the operator may collect the activated sludge 124 to be returned to the stabilization tank. The operator may add the returning activated sludge 124A to the stabilization tank during step 1075 and then proceed to step 1080. During step 1080, the contact stabilization system 400 may digest any activated sludge 124 that was not returned to the stabilization tank. The operator may decide whether it is necessary to add the cationic clay composition to the wasted activated sludge 124B during step 1082. The operator may take an action based on this determination in step 1084. If the operator determines that it is not necessary to add the cationic clay composition to the wasted activated sludge 124B, the operator may proceed to step 1088. If the operator determines it is necessary to add the cationic clay composition to the wasted activated sludge 124B, the operator may proceed to step 1086, wherein the operator may add the cationic clay composition to the wasted activated sludge 124B. Reasons an operator may want to add the cationic clay composition to the wasted activated sludge 124B during digestion includes reducing the need to centrifuge the wasted activated sludge 124B by increasing the number of quality biomass and reducing the number of decants due to a higher amount of oxygen dissolved in the wastewater 102. This should result in a decrease in cost to digest the biomass compared to current methods. The operator may remove the wasted activated sludge 124B from the contact stabilization system 400 after digestion during step 1088. Once the wasted activated sludge 124B has been removed from the system, the method may proceed to the terminate method step 1099.

During step 1090, the supernatant 122 siphoned off during step 1055 may be disinfected by the disinfection apparatus 130 to create treated effluent 132. The operator may determine whether to add the cationic clay composition to the supernatant 122 during step 1092. The operator may take an action based on this determination in step 1094. If the operator determines that it is not necessary to add the cationic clay composition to the supernatant 122, the operator may proceed to step 1098. If the operator determines it is necessary to add the cationic clay composition to the supernatant 122, the operator may proceed to step 1096, wherein the operator may add the cationic clay composition to the supernatant 122. Reasons an operator may want to add the cationic clay composition to the supernatant 122 includes further decreasing chlorine usage for disinfection, thus lowering the cost of disinfection and formation of chloramines and trichloromethanes. Addition of the cationic clay composition to the supernatant 122 as well may decrease turbidity, which may further decrease the costs of operation. The treated effluent 132 may then be added to the receiving waters 104 during step 1098. Once the treated effluent has been added to the receiving waters 104, the method may proceed to the terminate method step 1099.

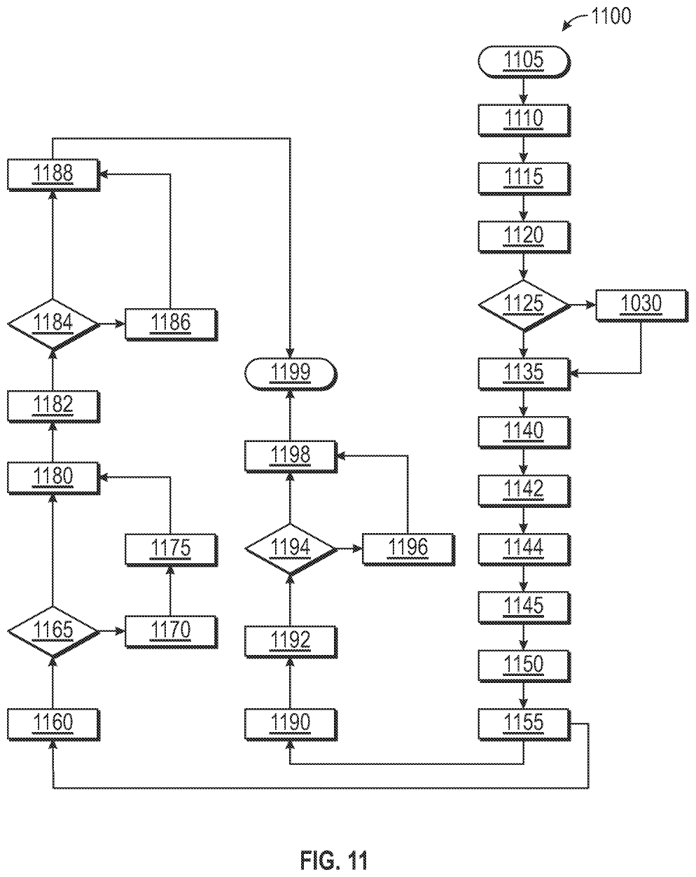

FIG. 11 provides a flow chart 1100 illustrating certain method steps that may be used to carry out the process of treating wastewater 102 in a system comprising a fixed film reactor 515, as illustrated in FIG. 5, using the various injection sites 107. Step 1105 indicates the beginning of the method. During step 1110, an operator may obtain a cationic clay composition that may be used to floc out biomass within wastewater 102. During step 1115, the operator may obtain a coagulating polymer that may be used to create a precipitate in conjunction with the cationic clay composition. Wastewater 102 may then be collected by the wastewater collection apparatus 105, and the operator may decide whether it is necessary to add the cationic clay composition to the wastewater 102 during step 1120. The operator may take an action based on this determination during step 1125. If the operator determines that it is not necessary to add the cationic clay composition to the wastewater 102, the operator may proceed to step 1135. If the operator determines it is necessary to add the cationic clay composition to the wastewater 102, the operator may proceed to step 1130, wherein the operator may add the cationic clay composition to the wastewater 102 after collection. Reasons an operator may want to add the cationic clay composition to wastewater 102 after collection in a fixed film system 500 includes reducing ammonia compounds earlier in the treatment process. This in turn reduces hydrogen sulfide, which could result in less infrastructure corrosion. Additionally, introduction of the cationic clay composition at this point may reduce the number of large solids suspended in the wastewater 102, thus increasing the effectiveness of preliminary treatment and reducing the need for maintenance. Further, introduction of the cationic clay composition at this point may assist in odor control throughout the treatment process. Once the cationic clay composition has been added to the wastewater 102, the method may proceed to step 1135.

After collection, the wastewater 102 may be screened by the preliminary treatment apparatus 110 during step 1135. After screening, the wastewater 102 may be clarified during step 1140 such that the cationic clay composition and biomass floc out of the sludge water 117. In some optional embodiments, the operator may add the coagulating polymer to the wastewater 102 within the clarifier to help the cationic clay composition floc out the biomass suspended throughout the wastewater 102. In other optional embodiments, the operator may add the cationic clay composition during clarification to prevent ashing within the clarifier, resulting in higher quality wastewater 102 and reducing the amount of chlorine needed for disinfection. Alternatively, an operator may skip the addition of either the coagulating polymer or cationic clay composition to the sludge water 117 within the clarifier. After clarification, the clarified wastewater 102 may then be agitated via the fixed film reactor 515 during step 1142, and the operator may add the cationic clay composition to the wastewater 102 leaving the fixed film reactor 515 during step 1144 to create sludge water 117. Addition of the cationic clay composition to wastewater 102 leaving the fixed film reactor 515 decreases turbidity of the wastewater 102, reducing the amount of chlorine necessary to treat the supernatant 122 during the disinfection process and makes sludge 124 more compact. It may also reduce the ashing that may occur during clarification.

After addition of the cationic clay composition, the sludge water 117 may be clarified during step 1145 such that the cationic clay composition and biomass floc out of the sludge water 117, thus creating a clear supernatant 122 and activated sludge 124. During step 1150, the operator may add the coagulating polymer to the sludge water 117 within the clarifier to help the cationic clay composition floc out the biomass within the sludge water 117. In some optional embodiments, the operator may add the cationic clay composition during clarification to prevent ashing within the clarifier, resulting in an even clearer supernatant 122 and further reducing the amount of chlorine needed for disinfection. Alternatively, an operator may skip the addition of either the coagulating polymer or cationic clay composition to the sludge water 117 within the clarifier. The activated sludge 124 may be collected by the operator and the supernatant 122 siphoned off and sent to disinfection during step 1155. The method may then proceed to steps 1160 and 1190.

The operator may determine whether it is necessary to return a portion of the activated sludge 124 to the stabilization tank during step 1160. The operator may take an action based on this determination during step 1165. If the operator determines that it is not necessary to return activated sludge 124 to the stabilization tank, the operator may proceed to step 1180. If the operator determines it is necessary to return a portion of the activated sludge 124 to the stabilization tank, the operator may proceed to step 1170, wherein the operator may collect the activated sludge 124 to be returned to the stabilization tank. The operator may add the returning activated sludge 124A to the stabilization tank during step 1175 and then proceed to step 1180. During step 1180, the fixed film system 500 may digest any activated sludge 124 that was not returned to the stabilization tank. The operator may decide whether it is necessary to add the cationic clay composition to the wasted activated sludge 124B during step 1182. The operator may take an action based on this determination in step 1184. If the operator determines that it is not necessary to add the cationic clay composition to the wasted activated sludge 124B, the operator may proceed to step 1188. If the operator determines it is necessary to add the cationic clay composition to the wasted activated sludge 124B, the operator may proceed to step 1186, wherein the operator may add the cationic clay composition to the wasted activated sludge 124B. Reasons an operator may want to add the cationic clay composition to the wasted activated sludge 124B during digestion includes reducing the need to centrifuge the wasted activated sludge 124B by increasing the quality of biomass and reducing the number of decants due to a higher amount of oxygen dissolved in the wastewater 102. This should result in a decrease in cost to digest the biomass compared to current methods. The operator may remove the wasted activated sludge 124B from the fixed film system 500 after digestion during step 1188. Once the wasted activated sludge 124B has been removed from the system, the method may proceed to the terminate method step 1199.

During step 1190, the supernatant 122 siphoned off during step 1155 may be disinfected by the disinfection apparatus 130 to create treated effluent 132. The operator may determine whether to add the cationic clay composition to the supernatant 122 during step 1192. The operator may take an action based on this determination in step 1194. If the operator determines that it is not necessary to add the cationic clay composition to the supernatant 122, the operator may proceed to step 1199. If the operator determines it is necessary to add the cationic clay composition to the supernatant 122, the operator may proceed to step 1196, wherein the operator may add the cationic clay composition to the supernatant 122. Reasons an operator may want to add the cationic clay composition to the supernatant 122 includes further decreasing chlorine usage for disinfection, thus lowering the cost of disinfection. Addition of the cationic clay composition to the supernatant 122 as well may decrease turbidity, which may further decrease the costs of operation. The treated effluent 132 may then be added to the receiving waters 104 during step 1198. Once the water has been added to the receiving waters 104, the method may proceed to the terminate method step 1199.

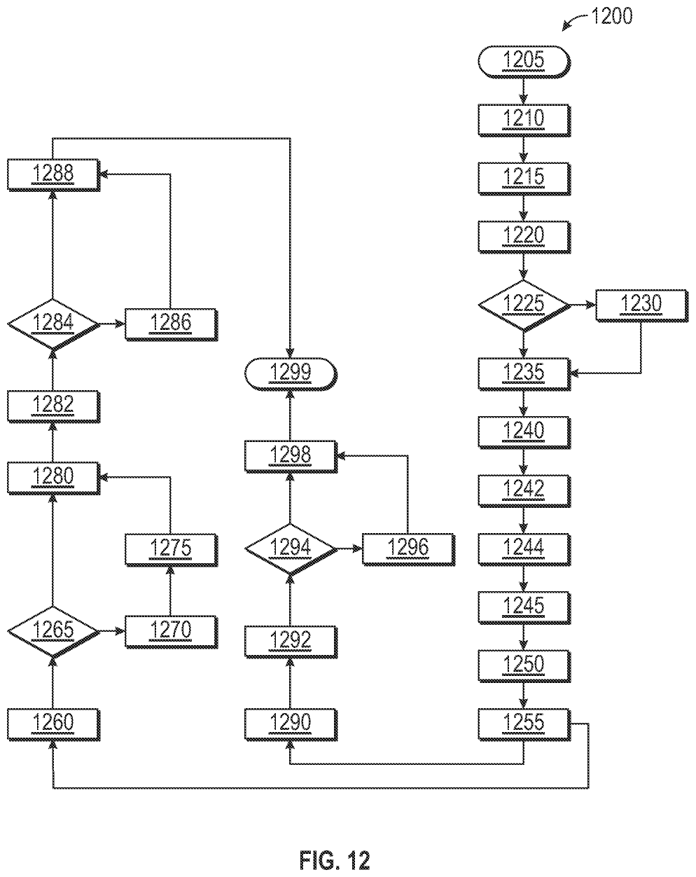

FIG. 12 provides a flow chart 1200 illustrating certain method steps that may be used to carry out the process of treating wastewater 102 in a system comprising a plug flow reactor 615, as illustrated in FIG. 6, using the various injection sites 107. Step 1205 indicates the beginning of the method. During step 1210, an operator may obtain a cationic clay composition that may be used to floc out biomass within wastewater 102. During step 1215, the operator may obtain a coagulating polymer that may be used to create a precipitate in conjunction with the cationic clay composition. Wastewater 102 may then be collected by the wastewater collection apparatus 105, and the operator may decide whether it is necessary to add the cationic clay composition to the wastewater 102 during step 1220. The operator may take an action based on this determination during step 1225. If the operator determines that it is not necessary to add the cationic clay composition to the wastewater 102, the operator may proceed to step 1235. If the operator determines it is necessary to add the cationic clay composition to the wastewater 102, the operator may proceed to step 1230, wherein the operator may add the cationic clay composition to the wastewater 102 after collection. Reasons an operator may want to add the cationic clay composition to wastewater 102 after collection in a plug flow system 600 includes reducing ammonia compounds earlier in the treatment process. This in turn reduces hydrogen sulfide, which could result in less infrastructure corrosion. Additionally, introduction of the cationic clay composition at this point may reduce the number of large solids suspended in the wastewater 102, thus increasing the effectiveness of preliminary treatment and reducing the need for maintenance. Further, introduction of the cationic clay composition at this point may assist in odor control throughout the treatment process. Once the cationic clay composition has been added to the wastewater 102, the method may proceed to step 1235.

After collection, the wastewater 102 may be screened by the preliminary treatment apparatus 110 during step 1235. After screening, the wastewater 102 may be clarified during step 1240 such that the cationic clay composition and biomass floc out of the sludge water 117. In some optional embodiments, the operator may add the coagulating polymer to the wastewater 102 within the clarifier to help the cationic clay composition floc out the biomass suspended throughout the wastewater 102. In other optional embodiments, the operator may add the cationic clay composition immediately before or during clarification to prevent ashing within the clarifier, resulting in higher quality wastewater 102 and reducing the amount of chlorine needed for disinfection. Alternatively, an operator may skip the addition of either the coagulating polymer or cationic clay composition to the wastewater 102 within the clarifier. After clarification, the clarified wastewater 102 may then be agitated via the plug flow reactor 615 during step 1242, and the operator may add the cationic clay composition to the wastewater 102 leaving the plug flow reactor 615 during step 1244 to create sludge water 117. Addition of the cationic clay composition to wastewater 102 leaving the plug flow reactor 615 prevents colloidal biological particles from escaping the weir walls. Addition of the cationic clay composition may decrease turbidity and reduce the number of biomass suspended within the supernatant. This may also reduce the amount of chlorine necessary to treat the supernatant 122 during the disinfection process. Addition of the cationic clay composition to wastewater 102 after passing though the plug flow reactor 615 may also reduce ashing that may occur during clarification.

After addition of the cationic clay composition, the sludge water 117 may be clarified during step 1245 such that the cationic clay composition and biomass floc out of the sludge water 117, thus creating a clear supernatant 122 and activated sludge 124. During step 1250, the operator may add the coagulating polymer to the sludge water 117 within the clarifier to help the cationic clay composition floc out the biomass within the sludge water 117. In some optional embodiments, the operator may add the cationic clay composition during clarification to prevent ashing within the clarifier, resulting in an even clearer supernatant 122 and further reducing the amount of chlorine needed for disinfection. Alternatively, an operator may skip the addition of either the coagulating polymer or cationic clay composition to the sludge water 117 within the clarifier. The activated sludge 124 may be collected by the operator and the supernatant 122 siphoned off and sent to disinfection during step 1255. The method may then proceed to steps 1260 and 1290.

The operator may determine whether it is necessary to return a portion of the activated sludge 124 to the stabilization tank during step 1260. The operator may take an action based on this determination during step 1265. If the operator determines that it is not necessary to return activated sludge 124 to the stabilization tank, the operator may proceed to step 1280. If the operator determines it is necessary to return a portion of the activated sludge 124 to the stabilization tank, the operator may proceed to step 1270, wherein the operator may collect the activated sludge 124 to be returned to the stabilization tank. The operator may add the returning activated sludge 124A to the stabilization tank during step 1275 and then proceed to step 1280. During step 1280, the plug flow system 600 may digest any activated sludge 124 that was not returned to the stabilization tank. The operator may decide whether it is necessary to add the cationic clay composition to the wasted activated sludge 124B during step 1282. The operator may take an action based on this determination in step 1284. If the operator determines that it is not necessary to add the cationic clay composition to the wasted activated sludge 124B, the operator may proceed to step 1288. If the operator determines it is necessary to add the cationic clay composition to the wasted activated sludge 124B, the operator may proceed to step 1286, wherein the operator may add the cationic clay composition to the wasted activated sludge 124B. Reasons an operator may want to add the cationic clay composition to the wasted activated sludge 124B during digestion includes reducing the need to centrifuge the wasted activated sludge 124B by increasing the number of quality biomass and reducing the number of decants due to a higher amount of oxygen dissolved in the wastewater 102. This should result in a decrease in cost to digest the biomass compared to current methods. The operator may remove the wasted activated sludge 124B from the plug flow system 600 after digestion during step 1288. Once the wasted activated sludge 124B has been removed from the system, the method may proceed to the terminate method step 1299.

During step 1290, the supernatant 122 siphoned off during step 1255 may be disinfected by the disinfection apparatus 130 to create treated effluent 132. The operator may determine whether to add the cationic clay composition to the supernatant 122 during step 1292. The operator may take an action based on this determination in step 1294. If the operator determines that it is not necessary to add the cationic clay composition to the supernatant 122, the operator may proceed to step 1298. If the operator determines it is necessary to add the cationic clay composition to the supernatant 122, the operator may proceed to step 1296, wherein the operator may add the cationic clay composition to the supernatant 122. Reasons an operator may want to add the cationic clay composition to the supernatant 122 includes further decreasing chlorine usage for disinfection, thus lowering the cost of disinfection. Additionally, addition of the cationic clay composition to the supernatant 122 as well may decrease turbidity, which may further decrease the costs of operation. The treated effluent 132 may then be added to the receiving waters 104 during step 1298. Once the treated effluent has been added to the receiving waters 104, the method may proceed to the terminate method step 1299.

Although the systems and processes of the present disclosure have been discussed for use within the wastewater treatment field, one of skill in the art will appreciate that the inventive subject matter disclosed herein may be utilized in other fields or for other applications in which wastewater treatment is needed. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and process stages which have been described and illustrated in order to explain the nature of this inventive subject matter can be made without departing from the principles and scope of the inventive subject matter.

What is claimed is:

A process for treating wastewater, wherein said process comprises the steps of:
obtaining a cationic clay composition that acts as a flocculant,
collecting wastewater containing suspended biomass,
screening said wastewater,
adding said cationic clay composition to said wastewater to promote flocculation,
treating said wastewater containing said cationic clay composition with a secondary treatment apparatus to form activated sludge,
removing said activated sludge from said wastewater to create supernatant, and
disinfecting said supernatant to create effluent.

The process of claim 1, wherein said cationic clay composition is added to said wastewater prior to screening.

The process of claim 1, wherein said cationic clay composition is added to said wastewater after screening.

The process of claim 1, wherein said cationic clay composition is added to said wastewater during treatment with said secondary treatment apparatus.

The process of claim 1, wherein said cationic clay composition is added to said wastewater after treatment with said secondary treatment apparatus.

The process of claim 1, wherein said cationic clay composition is added to said supernatant during disinfection.

The process of claim 1, wherein said cationic clay composition comprises at least seventy weight percent cationic phyllosilicates and up to twenty weight percent titanium dioxide.

The process of claim 1, wherein said cationic clay composition comprises cationic phyllosilicates, titanium dioxide, and coagulating polymer.

The process of claim 1, wherein said cationic clay composition is mixed with said wastewater at a rate of at least 0.0025 pounds per gallon.

The process of claim 1, wherein said secondary treatment apparatus comprises at least one of an oxidation ditch system, extended aeration system, contact stabilization system, fixed film system, plug flow system, and sequence batch system.

The process of claim 1, further comprising the step of:
returning said activated sludge to said wastewater prior to treatment with said secondary treatment apparatus.

The process of claim 11, wherein said activated sludge is returned at a rate of at least 1.0 gram per liter of mixed liquor suspended solids.

The process of claim 1, further comprising the step of:
digesting said activated sludge removed from said wastewater.

The process of claim 1, further comprising the steps of:

making a slurry comprising said cationic clay composition and water, and adding said slurry to said wastewater.

The process of claim 14, wherein said slurry comprises at least eighty weight percent cationic clay composition and up to twenty weight percent water.

A process for treating wastewater, wherein said process comprises the steps of:
obtaining a cationic clay composition that acts as a flocculant,
collecting wastewater containing suspended biomass,
screening said wastewater,
adding said cationic clay composition to said wastewater to promote flocculation, agitating said wastewater containing said cationic clay composition to form activated sludge,
removing said activated sludge from said wastewater to create supernatant, clarifying said wastewater prior to removal of said activated sludge, and disinfecting said supernatant to create effluent.

The process of claim 16, wherein said cationic clay composition is added to said wastewater prior to screening.

The process of claim 16, wherein said cationic clay composition is added to said wastewater after screening.

The process of claim 16, wherein said cationic clay composition is added to said wastewater during agitation.

The process of claim 16, wherein said cationic clay composition is added to said wastewater after agitation.

The process of claim 16, wherein said cationic clay composition is added to said wastewater during clarification.

The process of claim 16, wherein said cationic clay composition is added to said supernatant during disinfection.

The process of claim 16, wherein said cationic clay composition comprises at least seventy weight percent cationic phyllosilicates and up to twenty weight percent titanium dioxide.

The process of claim 16, wherein said cationic clay composition comprises cationic phyllosilicates, titanium dioxide, and coagulating polymer.

The process of claim 16, wherein said cationic clay composition is mixed with said wastewater at a rate of at least 0.0025 pounds per gallon.

The process of claim 16, wherein agitation of said wastewater takes place in at least one of an oxidation ditch system, extended aeration system, contact stabilization system, fixed film system, plug flow system, and sequence batch system.

The process of claim 16, further comprising the step of: returning said activated sludge to said wastewater prior to agitation.

The process of claim 27, wherein said activated sludge is returned at a rate of at least 1.0 gram per liter of mixed liquor suspended solids.

The process of claim 16, further comprising the steps of:
making a slurry comprising said cationic clay composition and water, and
adding said slurry to said wastewater.

The process of claim 29, wherein said slurry comprises at least eighty weight percent cationic clay composition and up to twenty weight percent water.

A process for treating wastewater, wherein said process comprises the steps of:
obtaining a cationic clay composition that acts as a flocculant,
   wherein said cationic clay composition comprises at least seventy weight percent cationic phyllosilicates and up to twenty weight percent titanium dioxide,
obtaining a coagulating polymer that creates activated sludge with said cationic clay composition,
collecting wastewater containing suspended biomass,
screening said wastewater,
adding said cationic clay composition to said wastewater to promote flocculation,
adding said coagulating polymer to said wastewater to promote coagulation,
agitating said wastewater containing said cationic clay composition and said coagulating polymer to form activated sludge,
clarifying said wastewater prior to removal of said activated sludge, removing said activated sludge from said wastewater to create supernatant, and disinfecting said supernatant to create effluent.

The process of claim 31, wherein said cationic clay composition comprises cationic phyllosilicates, titanium dioxide, and coagulating polymer.

The process of claim 31, wherein said cationic clay composition is mixed with said wastewater at a rate of at least 0.0025 pounds per gallon.

The process of claim 31, wherein agitation of said wastewater takes place in at least one of an oxidation ditch system, extended aeration system, contact stabilization system, fixed film system, plug flow system, and sequence batch system.

The process of claim 31, further comprising the step of:
returning said activated sludge to said wastewater prior to agitation.

The process of claim 35, wherein said activated sludge is returned at a rate of at least 1.0 gram per liter of mixed liquor suspended solids.

The process of claim 31, further comprising the steps of:
making a slurry comprising said cationic clay composition and water, and adding said slurry to said wastewater.
The process of claim 37, wherein said slurry comprises at least eighty weight percent cationic clay composition and up to twenty weight percent water.

What is claimed is:

1) A process for treating wastewater, wherein said process comprises the steps of:
obtaining a cationic clay composition that acts as a flocculant,
collecting wastewater containing suspended biomass,
screening said wastewater,
adding said cationic clay composition to said wastewater to promote flocculation, treating said wastewater containing said cationic clay composition with a secondary treatment apparatus to form activated sludge,
removing said activated sludge from said wastewater to create supernatant, and disinfecting said supernatant to create effluent.

2) The process of claim 1, wherein said cationic clay composition is added to said wastewater prior to screening.

3) The process of claim 1, wherein said cationic clay composition is added to said wastewater after screening.

4) The process of claim 1, wherein said cationic clay composition is added to said wastewater during treatment with said secondary treatment apparatus.

5) The process of claim 1, wherein said cationic clay composition is added to said wastewater after treatment with said secondary treatment apparatus.

6) The process of claim 1, wherein said cationic clay composition is added to said supernatant during disinfection.

7) The process of claim 1, wherein said cationic clay composition comprises at least seventy weight percent cationic phyllosilicates and up to twenty weight percent titanium dioxide.

8) The process of claim 1, wherein said cationic clay composition comprises cationic phyllosilicates, titanium dioxide, and coagulating polymer.

9) The process of claim 1, wherein said cationic clay composition is mixed with said wastewater at a rate of at least 0.0025 pounds per gallon.

10) The process of claim 1, wherein said secondary treatment apparatus comprises at least one of an oxidation ditch system, extended aeration system, contact stabilization system, fixed film system, plug flow system, and sequence batch system.

11) The process of claim 1, further comprising the step of:
returning said activated sludge to said wastewater prior to treatment with said secondary treatment apparatus.

12) The process of claim 11, wherein said activated sludge is returned at a rate of at least 1.0 gram per liter of mixed liquor suspended solids.

13) The process of claim 1, further comprising the step of:
digesting said activated sludge removed from said wastewater.

14) The process of claim 1, further comprising the steps of:
making a slurry comprising said cationic clay composition and water, and adding said slurry to said wastewater.

15) The process of claim 14, wherein said slurry comprises at least eighty weight percent cationic clay composition and up to twenty weight percent water.

16) A process for treating wastewater, wherein said process comprises the steps of:
obtaining a cationic clay composition that acts as a flocculant,
collecting wastewater containing suspended biomass,
screening said wastewater,
adding said cationic clay composition to said wastewater to promote flocculation,
agitating said wastewater containing said cationic clay composition to form activated sludge,
removing said activated sludge from said wastewater to create supernatant,
clarifying said wastewater prior to removal of said activated sludge, and
disinfecting said supernatant to create effluent.

17) The process of claim 16, wherein said cationic clay composition is added to said wastewater prior to screening.

18) The process of claim 16, wherein said cationic clay composition is added to said wastewater after screening.

19) The process of claim 16, wherein said cationic clay composition is added to said wastewater during agitation.

20) The process of claim 16, wherein said cationic clay composition is added to said wastewater after agitation.

21) The process of claim 16, wherein said cationic clay composition is added to said wastewater during clarification.

22) The process of claim 16, wherein said cationic clay composition is added to said supernatant during disinfection.

23) The process of claim 16, wherein said cationic clay composition comprises at least seventy weight percent cationic phyllosilicates and up to twenty weight percent titanium dioxide.

24) The process of claim 16, wherein said cationic clay composition comprises cationic phyllosilicates, titanium dioxide, and coagulating polymer.

25) The process of claim 16, wherein said cationic clay composition is mixed with said wastewater at a rate of at least 0.0025 pounds per gallon.

26) The process of claim 16, wherein agitation of said wastewater takes place in at least one of an oxidation ditch system, extended aeration system, contact stabilization system, fixed film system, plug flow system, and sequence batch system.

27) The process of claim 16, further comprising the step of:
returning said activated sludge to said wastewater prior to agitation.

28) The process of claim 27, wherein said activated sludge is returned at a rate of at least 1.0 gram per liter of mixed liquor suspended solids.

29) The process of claim 16, further comprising the steps of:
making a slurry comprising said cationic clay composition and water, and
adding said slurry to said wastewater.

30) The process of claim 29, wherein said slurry comprises at least eighty weight percent cationic clay composition and up to twenty weight percent water.

31) A process for treating wastewater, wherein said process comprises the steps of:
obtaining a cationic clay composition that acts as a flocculant,
wherein said cationic clay composition comprises at least seventy weight percent cationic phyllosilicates and up to twenty weight percent titanium dioxide,
obtaining a coagulating polymer that creates activated sludge with said cationic clay composition,
collecting wastewater containing suspended biomass,
screening said wastewater,
adding said cationic clay composition to said wastewater to promote flocculation,
adding said coagulating polymer to said wastewater to promote coagulation,
agitating said wastewater containing said cationic clay composition and said coagulating polymer to form activated sludge,
clarifying said wastewater prior to removal of said activated sludge,
removing said activated sludge from said wastewater to create supernatant, and
disinfecting said supernatant to create effluent.

32) The process of claim 31, wherein said cationic clay composition comprises cationic phyllosilicates, titanium dioxide, and coagulating polymer.

33) The process of claim 31, wherein said cationic clay composition is mixed with said wastewater at a rate of at least 0.0025 pounds per gallon.

34) The process of claim 31, wherein agitation of said wastewater takes place in at least one of an oxidation ditch system, extended aeration system, contact stabilization system, fixed film system, plug flow system, and sequence batch system.

35) The process of claim 31, further comprising the step of:
returning said activated sludge to said wastewater prior to agitation.

36) The process of claim 35, wherein said activated sludge is returned at a rate of at least 1.0 gram per liter of mixed liquor suspended solids.

37) The process of claim 31, further comprising the steps of:
making a slurry comprising said cationic clay composition and water, and adding said slurry to said wastewater.

38) The process of claim 37, wherein said slurry comprises at least eighty weight percent cationic clay composition and up to twenty weight percent water.
